(19) United States
(12) Patent Application Publication
(10) Pub. No.: US 2006/0271700 A1
(43) Pub. Date: Nov. 30, 2006

(54) Record medium with a load distribution program recorded thereon, load distribution method, and load distribution apparatus

(75) Inventors: Tsutomu Kawai, Kawasaki (JP); Atsuji Sekiguchi, Kawasaki (JP); Satoshi Tsuchiya, Kawasaki (JP); Kazuki Shimojima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/226,217

(22) Filed: Sep. 15, 2005

(30) Foreign Application Priority Data
May 24, 2005 (JP) 2005-150418

(51) Int. Cl. G06F 15/16

(52) U.S. Cl. 709/233

(57) ABSTRACT

A record medium on which a load distribution program capable of dynamically determining a service providing server which can provide a service of high quality according to a place where a client is installed is recorded. A delay time determination section analyzes a request sent from a client, identifies a position on a network of the client, and determines processing delay time the client takes to receive a response from each data center on the basis of a communication path between the position of the client and a position on the network of each data center. An allocation determination section preferentially selects a data center which can provide a service to the client after shortest processing delay time as a recommended data center on the basis of the processing delay time determined by the delay time determination section. A service allocation section makes a server in the recommended data center provide the service to the client which outputted the request.

### CROSS-REFERENCE TO RELATED APPLICATIONS

This application is based upon and claims the benefits of priority from the prior Japanese Patent Application No. 2005-150418, filed on May 24, 2005, the entire contents of which are incorporated herein by reference.

### BACKGROUND OF THE INVENTION

(1) Field of the Invention

This invention relates to a record medium on which a load distribution program for distributing a processing load on each of a plurality of servers is recorded, a load distribution method, and a load distribution apparatus and, more particularly, to a record medium on which a load distribution program for dynamically determining a server for performing a process each time a process request is received from a client is recorded, a load distribution method, and a load distribution apparatus.

(2) Description of the Related Art

In ordinary client server systems, the quantity requested by clients are estimated in advance and resources, such as servers and networks, which are required to provide services are secured. The secured resources are then used for providing the services for the clients.

With the rapid spread of the Internet in recent years, however, it has become difficult to estimate a resource quantity required in the future. In particular, the quantity requested may increase temporarily and sharply because of, for example, events held only for a limited period of time if network services are provided for consumers via the Web. In such a case, it is especially difficult to estimate a resource quantity required. If there is an error in estimating the quantity requested per unit time, then there are delays in providing services at the time of a flood of requests.

There is a method not only for improving efficiency in the operation of services by dynamically increasing or decreasing a resource quantity but also for enhancing efficiency in the use of resources by sharing a spare resource among a plurality of services. A network environment in which such resource management is performed is called an on-demand environment.

In an on-demand environment, a necessary resource quantity can be secured properly even when the quantity requested increases sharply. In addition, spare resources are installed in a plurality of centers and are shared by them. By doing so, efficiency in the use of the resources can be enhanced.

Even in such an on-demand environment, fine management according to users is required for a service differentiation. To manage users in an on-demand environment, information specific to the users must be shared among data centers and service quality must be managed according to user classes. In this case, information management can be exercised by connecting the data centers via networks. However, if other conditions are not considered, service quality mismatching may occur among service classes.

That is to say, the condition of networks between users and data centers, the loads on servers, delays on back-end networks, etc. must be taken into consideration in order to properly maintain quality as seen from the point of view of users. A server must be added or control, such as a change of server between users, must be exercised so as to guarantee a delay or quality set for each user.

For example, a technique which can adjust resource capacity on a server on demand according to demand is proposed (see Japanese Patent Laid-Open Publication No. 2001-067377).

However, the technique disclosed in Japanese Patent Laid-Open Publication No. 2001-067377 is for distributing static contents. Cases where an application server is used or services in which a process is divided into many layers are not taken into consideration. Moreover, when services are allocated or when centers are selected, other user characteristics or allocation control by adjusting a plurality of services is not taken into consideration. That is to say, a resource quantity is examined, but the quality of a resource allocated is not taken into consideration.

In this case, a resource quantity indicates capability to provide services for clients, and resource quality indicates whether services of higher quality can be provided for clients. Resource quality is determined by, for example, the length of time (delay time) which elapses after a client outputs a request and before the client receives a response.

In a client server system in which requests are sent and received via networks, usually not only time it takes a server to perform a process but also time it takes to perform communication between a client and the server and between the server and a back-end server must be taken into consideration to determine performance as seen from the point of view of the client. Therefore, a server located on a network near the client should be used as a server for performing a process corresponding to a request from the client.

In an on-demand environment, usually there may be a plurality of centers which provide services. Accordingly, by giving a client instructions to use a center located on a network near the client, performance as seen from point of view of the client can be improved. That is to say, a resource in the center located on the network near the user is a high-quality resource for the user.

If clients and centers are scattered, then centers which includes resources of the highest quality differ among different clients. In this case, by allocating resources to each center on demand according to the distribution of the clients and allocating these resources to the clients, the highest service quality can be obtained.

Actually, there may be factors, such as a resource quantity which can be secured in each center and uneven distribution of users, so it is difficult to allocate each client to the most suitable center. Moreover, even if each client can be allocated to the most suitable center, there is often waste in the use of resources. Accordingly, it is necessary to select possible centers within service quality required. Some services may strongly be influenced not by delay in communication between a client and a server but by delay in communication between a server and a back-end server.

In a conventional client server system a server and a back-end server are installed in the same center, so there is no need to take delay in communication between them into consideration. However, if servers are allocated according to processing layers in an on-demand environment, delay between the processing layers must also be taken into consideration. In actual services clients may be classified. At news sites, for example, services may be provided preferentially to members who pay fees, and services of lower quality may be provided to users who do not pay fees.

In such a case, a service differentiation can be made on the basis of client classes by providing services of high quality to the members who pay fees, that is to say, by preferentially allocating resources in centers for which a communication process delay is short from the client's viewpoint to the members who pay fees.

Moreover, if a resource is added or removed, the most suitable center seen from the client's viewpoint changes. Therefore, users must be reallocated to centers according to a change in the situation.

In addition, when a resource is allocated to a service, performance seen from the client's viewpoint changes, depending on which center includes the resource. Accordingly, when a plurality of services are allocated to centers, allocation or reallocation must be performed in accordance with some rule.

### SUMMARY OF THE INVENTION

The present invention was made under the background circumstances described above. An object of the present invention is to provide a record medium on which a load distribution program capable of dynamically determining a service providing server which can provide a service of high quality according to a place where a client is installed is recorded, a load distribution method, and a load distribution apparatus.

In order to achieve the above object, a record medium on which a load distribution program for dynamically allocating requests from clients to a plurality of data centers is recorded is provided. This load distribution program makes a computer function as a delay time determination section for analyzing a request sent from a client, for identifying a position on a network of the client, and for determining processing delay time the client takes to receive a response from each data center on the basis of a communication path between the position of the client and a position on the network of each data center; an allocation determination section for preferentially selecting a data center which can provide a service to the client after shortest processing delay time as a recommended data center on the basis of the processing delay time determined by the delay time determination section; and a service allocation section for making a server in the recommended data center provide the service to the client which outputted the request.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for giving an overview of an embodiment of the present invention.

FIG. 2 shows an example of the configuration of a system according to the embodiment of the present invention.

FIG. 3 shows an example of the hardware configuration of a wide area load distribution apparatus.

FIG. 4 is a block diagram showing the function of the wide area load distribution apparatus.

FIG. 5 shows an example of the data structure of a service information table.

FIG. 6 shows an example of the data structure of a user information table.

FIG. 7 shows an example of the data structure of a service/user allocation table.

FIG. 8 shows an example of the data structure of a network delay calculation table.

FIG. 9 is a flow chart showing the procedure for a process performed by the wide area load distribution apparatus.

FIG. 10 is a flow chart showing the procedure for a user identification process.

FIG. 11 is a flow chart showing the procedure for a class determination process.

FIG. 12 is a flow chart showing the procedure for a network delay calculation process.

FIG. 13 is a flow chart showing the procedure for an allocation determination process.

FIG. 14 is a flow chart showing the procedure for a server addition process.

FIG. 15 is a flow chart showing the procedure for a center and server selection process (I).

FIG. 16 is a flow chart showing the procedure for a center and server selection process (II).

FIG. 17 is a flow chart showing the procedure for a user move process.

FIG. 18 is a flow chart showing the procedure for an all user rearrangement process.

FIG. 19 is the first half of a flow chart showing the procedure for an under- or overcapacity determination process.

FIG. 20 is the second half of the flow chart showing the procedure for the under- or overcapacity determination process.

FIG. 21 is a flow chart showing the procedure for a process performed by an intra-center load distribution unit.

FIG. 22 is a flow chart showing the procedure for a process performed by a server.

FIG. 23 is a flow chart showing the procedure for a process performed by a client.

FIG. 24 is a flow chart showing the procedure for a server real allocation process.

FIG. 25 is a flow chart showing the procedure for a server start-complete confirmation process.

FIG. 26 is a flow chart showing the procedure for a server real allocation cancel process.

### DESCRIPTION OF THE PREFERRED EMBODIMENTS

An embodiment of the present invention will now be described with reference to the drawings.

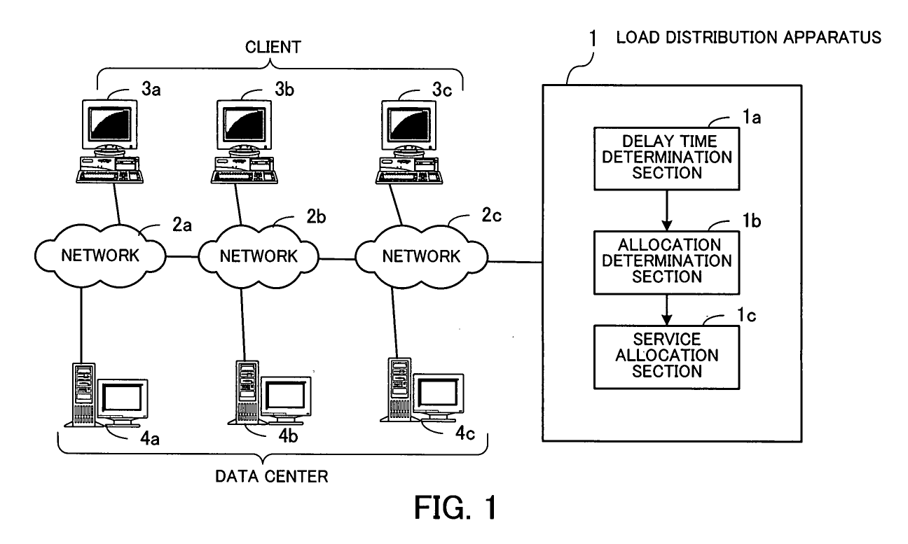

FIG. 1 is a view for giving an overview of an embodiment of the present invention. As shown in FIG. 1, a load distribution apparatus 1 is connected to clients 3a through 3c and data centers 4a through 4c via networks 2a through 2c. Each of the data centers 4a through 4c has one or more servers by which it provides predetermined services to the clients 3a through 3c. To dynamically allocate requests from the clients 3a through 3c to the data centers 4a through 4c, the load distribution apparatus 1 includes a delay time determination section 1a, an allocation determination section 1b, and a service allocation section 1c.

The delay time determination section 1a analyzes a request sent from a client and identifies a position on the network 2a, 2b, or 2c of the client. For example, the delay time determination section 1a specifies a server for Internet access services to which the client is connected on the basis of a source address included in the request. If the position on a network of the server for Internet access services is registered in the delay time determination section 1a in advance, then the position on a network of the client (which server controls the client) that sent the request is known.

The delay time determination section 1a then determines processing delay time the client takes to receive a response from each data center on the basis of a communication path between the position of the client and a position on a network of each data center.

For example, the client 3a and the data center 4a shown in FIG. 1 are connected only by the network 2a. Accordingly, processing delay time is obtained by adding together communication time on the network 2a and processing time in the data center 4a. The client 3a and the data center 4c are connected via the networks 2a through 2c. Accordingly, processing delay time is obtained by adding together communication time on the networks 2a through 2c and processing time in the data center 4c. A communication path between the client 3a and the data center 4c is long, so processing delay time is long.

The allocation determination section 1b preferentially selects a data center which can provide a service to the client after the shortest processing delay time as a recommended center on the basis of the processing delay time determined by the delay time determination section 1a. If the request is outputted from the client 3a, then the data center 4a is preferentially selected. If a surplus resource is insufficient in the data center 4a, then the data center 4b is selected because the service can be provided after the next shortest processing delay time.

The service allocation section 1c makes a server in the recommended center provide the service to the client which outputted the request.

For example, if the request is outputted from the client 3a and the data center 4a is selected as a recommended center, then the service allocation section 1c sends the client 3a a redirect message for giving it instructions to reaccess the data center 4a. The client 3a then sends a request to the data center 4a in response to the redirect message. A server in the data center 4a provides the service to the client 3a in response to the request from the client 3a.

In such a computer which executes a load distribution program, the delay time determination section 1a analyzes the request sent from, for example, the client 3a and identifies the position on a network of the client 3a. The delay time determination section 1a determines processing delay time the client 3a takes to receive a response from each of the data centers 4a through 4c on the basis of a communication path between the position of the client 3a and the position on a network of each of the data centers 4a through 4c. The allocation determination section 1b then examines whether or not the data center 4a which can provide the service to the client 3a after the shortest delay time can provide the service. If the data center 4a can provide the service, then the allocation determination section 1b selects it as a recommended center. The server in the data center 4a, being a recommended center, provides the service to the client 3a which outputted the request by the control of the service allocation section 1c.

The above load distribution apparatus 1 allocates a request to one of the data centers 4a through 4c, so a service can be provided to a client after short processing delay time. This improves service quality.

The embodiment of the present invention will now be described in detail.

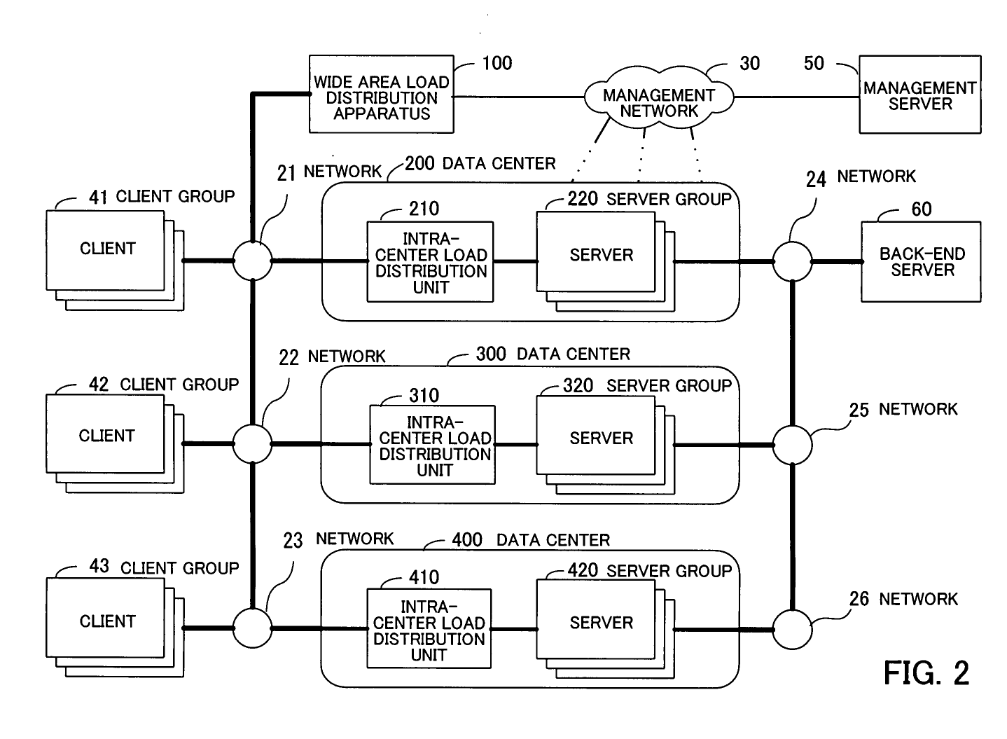

FIG. 2 shows an example of the configuration of a system according to the embodiment of the present invention. In a system according to the embodiment of the present invention, client groups 41, 42, and 43 are connected to different networks 21, 22, and 23 respectively. The networks 21, 22, and 23 form part of, for example, the Internet. Usually the Internet includes networks in areas (such as networks in providers) and sites (IXes (interconnection of networks in a plurality of providers), peering, etc.) where these networks are interconnected. In this example, they are indicated as the networks 21, 22, and 23.

Each of the client groups 41, 42, and 43 is a group of clients. A client is a unit which uses a service provided by a server. The networks 21 and 22 are interconnected. In addition, the networks 22 and 23 are interconnected.

The networks 21, 22, and 23 are connected to data centers 200, 300, and 400 respectively. A wide area load distribution apparatus 100 is connected to the network 21.

The wide area load distribution apparatus 100 determines a data center to which a request from a client used by a user is allocated. A user recognizes a data center to be used by inquiring of the wide area load distribution apparatus 100. Usually the wide area load distribution apparatus 100 will be installed in one of the data centers 200, 300, and 400.

To be concrete, the wide area load distribution apparatus 100 determines which data center and server should handle a request (for a service) from a client. In this case, the wide area load distribution apparatus 100 determines a data center according to the place where the client which outputs the request is installed so as to optimize processing efficiency. That is to say, clients and data centers are connected via a network group. However, delay time in communication between clients and data centers depends on how they are combined. Similarly, delay time in communication between a server and a fixed server differs among the different data centers. Therefore, the wide area load distribution apparatus 100 determines a data center to which the request from the client is allocated so as to shorten communication delay time.

In response to the request from the client, each of the data centers 200, 300, and 400 actually performs a process and provides a service by returning a response. In each of the data centers 200, 300, and 400, a given server is not allocated to the service and allocation is changed according to the load situation. That is to say, utility operation is performed. The data centers 200, 300, and 400 include a plurality of servers (server groups 220, 320, and 420 respectively) for operating a service and performing a process and intra-center load distribution units 210, 310, and 410, respectively, for allocating loads to servers.

The intra-center load distribution units 210, 310, and 410 are located at entries to the data centers 200, 300, and 400 respectively. The intra-center load distribution units 210, 310, and 410 accept access for the servers included in the data centers 200, 300, and 400, respectively, and transfer it to servers included in the data centers 200, 300, and 400, respectively. In this case, the intra-center load distribution units 210, 310, and 410 allocate requests to servers on which a load margin is left.

Each server in the server groups 220, 320, and 420 handles a request from a client and requests a back-end server 60 at need to handle it. Each server then returns a handling result to the client.

The server group 220 is connected to the back-end server 60 via a network 24. The server group 320 is connected to the back-end server 60 via a network 25 and the network 24. The server group 420 is connected to the back-end server 60 via a network 26 and the networks 24 and 25.

The back-end server 60 processes data in response to a request from a server included in the server group 220, 320, or 420. For example, the back-end server 60 has a database management function and acquires data from or updates data in a database in response to a request from another server.

That is to say, a function regarding, for example, a database which is difficult to distribute on demand is provided by the back-end server 60 connected to the data centers via the networks 24 through 26. Usually the networks 24 through 26 used in this case are management dedicated networks which are logically different from the Internet. The back-end server 60 may be operated by one of the data centers 200, 300, and 400 which provide services to users or be operated by a data center (data center in an enterprise which operates services, for example) other than the data centers 200, 300, and 400. The back-end server 60 may not exist, depending on the structure of a service.

The wide area load distribution apparatus 100, the intra-center load distribution units 210, 310, and 410, each server in the server groups 220, 320, and 420, and the back-end server 60 are connected to a management server 50 via a management network 30. The management server 50 sets and monitors each data center, the apparatus, and each unit. Like the back-end server 60, the management server 50 exercises control over each component via the management network 30.

To be concrete, the management server 50 collects state information from a component connected thereto via the management network 30 and manages an operating environment. For example, the management server 50 manages the load state of each of the server groups 220, 320, and 420 and adds a server which is prepared as a spare server to a server group the load on which is excessive. This server addition process is performed by the management server 50 exercising remote control over each unit in the data centers 200, 300, and 400.

The networks 21 through 23 which connect clients and the wide area load distribution apparatus 100 or the data centers 200, 300, and 400 are wide area distributed networks, such as the Internet. On the other hand, safe exclusive networks, such as dedicated lines, are used as the networks 24 through 26 which connect servers and the back-end server 60.

In the above-mentioned system, a client issues a request for a service to the wide area load distribution apparatus 100. The wide area load distribution apparatus 100 then determines a data center and a server which should handle the request. At this time the wide area load distribution apparatus 100 sends user information to an intra-center load distribution unit in the determined data center and the determined server. The user information is registered in the intra-center load distribution unit and the server.

The wide area load distribution apparatus 100 returns a redirect message in which an address corresponding to the determined data center is designated to the client. If the load on the server becomes excessive, then the management server 50 adds a server to each data center on demand.

The client outputs a request to the data center determined by the wide area load distribution apparatus 100 in response to the redirect message. This request is received by the intra-center load distribution unit. The intra-center load distribution unit then allocates the request to the server determined by the wide area load distribution apparatus 100.

The server which received the request performs a process corresponding to the request and returns a processing result to the client. The server accesses at need information stored in the back-end server 60.

In this embodiment, the wide area load distribution apparatus 100 takes the initiative in performing a load distribution process. To be concrete, the wide area load distribution apparatus 100 determines the data center and the server through the following procedure.

When the wide area load distribution apparatus 100 receives the request, the wide area load distribution apparatus 100 estimates delay time in communication between a user and each data center. The wide area load distribution apparatus 100 then calculates processing time for each data center by adding server processing time, back-end server processing time, and back net communication time (time which elapses after the back-end server 60 is requested to perform a process and before a result is received from the back-end server 60) to the communication delay time.

After that, the wide area load distribution apparatus 100 rearranges the calculated values in ascending order and determines whether or not unused processing capability or processing capability to be used by lower-class users suffices a quantity needed for the new user. If performance is sufficient and the processing time is smaller than or equal to a guarantee value, then the wide area load distribution apparatus 100 allocates the data center and the server to the user who outputted the request.

If processing capability can be secured and the processing time is greater than the guarantee value, then the wide area load distribution apparatus 100 allocates a data center which cannot satisfy the guarantee value for processing time to the user. In this case, the wide area load distribution apparatus 100 requests the management server 50 to add a server to a data center which can guarantee processing time to the user. After the addition of the server is completed, the wide area load distribution apparatus 100 moves the user to an appropriate data center (reallocates an appropriate data center to the user).

If the processing capability to be used by lower-class users is used for the allocation, then data centers and servers are reselected for these users in the same way. As a result, data centers which are to be allocated to these users are moved (these users are moved).

The hardware configuration of the wide area load distribution apparatus 100 will now be described.

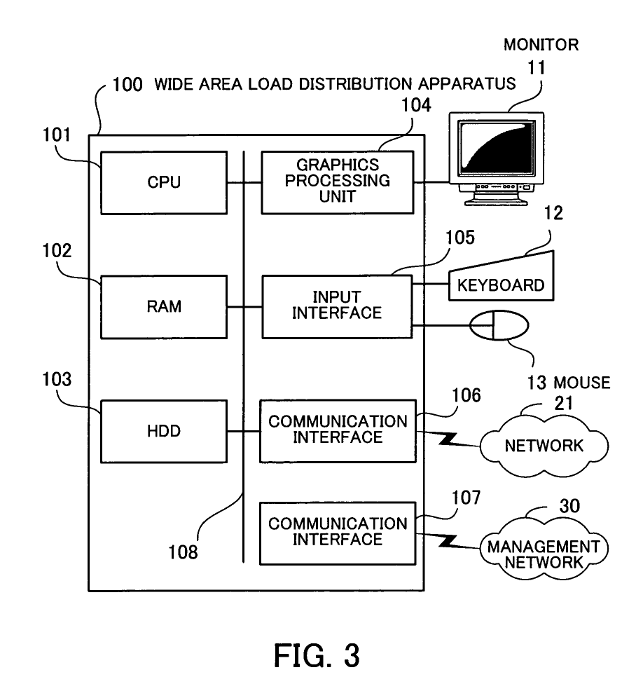

FIG. 3 shows an example of the hardware configuration of the wide area load distribution apparatus. The whole of the wide area load distribution apparatus 100 is controlled by a central processing unit (CPU) 101. A random access memory (RAM) 102, a hard disk drive (HDD) 103, a graphics processing unit 104, an input interface 105, and communication interfaces 106 and 107 are connected to the CPU 101 via a bus 108.

The RAM 102 temporarily stores at least part of an operating system (OS) or an application program executed by the CPU 101. The RAM 102 also stores various pieces of data which the CPU 101 needs to perform a process. The HDD 103 stores the OS and application programs.

A monitor 11 is connected to the graphics processing unit 104. In accordance with instructions from the CPU 101, the graphics processing unit 104 displays an image on a screen of the monitor 11. A keyboard 12 and a mouse 13 are connected to the input interface 105. The input interface 105 sends a signal sent from the keyboard 12 or the mouse 13 to the CPU 101 via the bus 108.

The communication interface 106 is connected to a network 21. The communication interface 106 exchanges data with a computer, such as a client, via the network 21.

The communication interface 107 is connected to the management network 30. The communication interface 107 exchanges data with the management server 50 via the management network 30.

By adopting the above-mentioned hardware configuration, the processing function of this embodiment can be realized. In FIG. 3, the hardware configuration of the wide area load distribution apparatus 100 is shown. However, each client, the intra-center load distribution units 210, 310, and 410, each server in the data centers 200, 300, and 400, the management server 50, and the back-end server 60 can also be realized by adopting the same hardware configuration.

The function of the wide area load distribution apparatus 100 will now be described in detail.

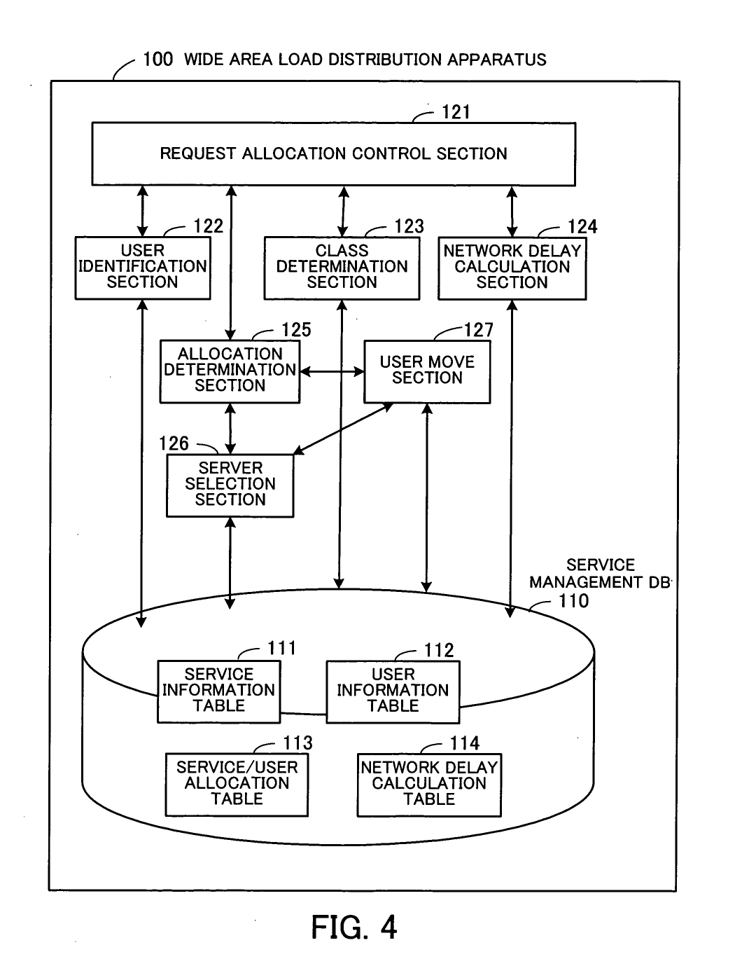

FIG. 4 is a block diagram showing the function of the wide area load distribution apparatus. The wide area load distribution apparatus 100 includes a service management database (DB) 110, a request allocation control section 121, a user identification section 122, a class determination section 123, a network delay calculation section 124, an allocation determination section 125, a server selection section 126, and a user move section 127.

Data necessary for allocating a request is stored in the service management DB 110. To be concrete, a service information table 111, a user information table 112, a service/user allocation table 113, and a network delay calculation table 114 are stored in the service management DB 110.

Information regarding a service provided by a server is registered in the service information table 111.

Information regarding a user to whom a service is provided is registered in the user information table 112.

Information indicative of users to whom server resources are currently allocated and server resource quantities allocated to these users is registered in the service/user allocation table 113.

An address of a server installed in a service provider for connecting a client and delay time on a network between the server and each data center are set in advance in the network delay calculation table 114.

The request allocation control section 121 accepts a request from a client and controls the process of determining a place to which the request is allocated. The request allocation control section 121 then returns a redirect message including the determined place to which the request is allocated to the client.

In response to a request from the request allocation control section 121, the user identification section 122 identifies a user who uses the client which outputted the request.

In response to a request from the request allocation control section 121, the class determination section 123 determines a class (users are grouped according to service quality levels) of the user who requests the providing of a service and delay time which is permissible in the class.

In response to a request from the request allocation control section 121, the network delay calculation section 124 determines delay time on a network between the client used by the user and each data center.

In response to a request from the request allocation control section 121, the allocation determination section 125 determines a data center and a server to which the request is to be allocated.

In response to a request from the allocation determination section 125, the server selection section 126 takes network delay time into consideration and selects a data center and a server which should handle the request.

In response to a request from the allocation determination section 125, the user move section 127 performs a user move process. The user move process means that the user allocated to the server which provides the service is reallocated to another server.

Information stored in the service management DB 110 will now be described concretely.

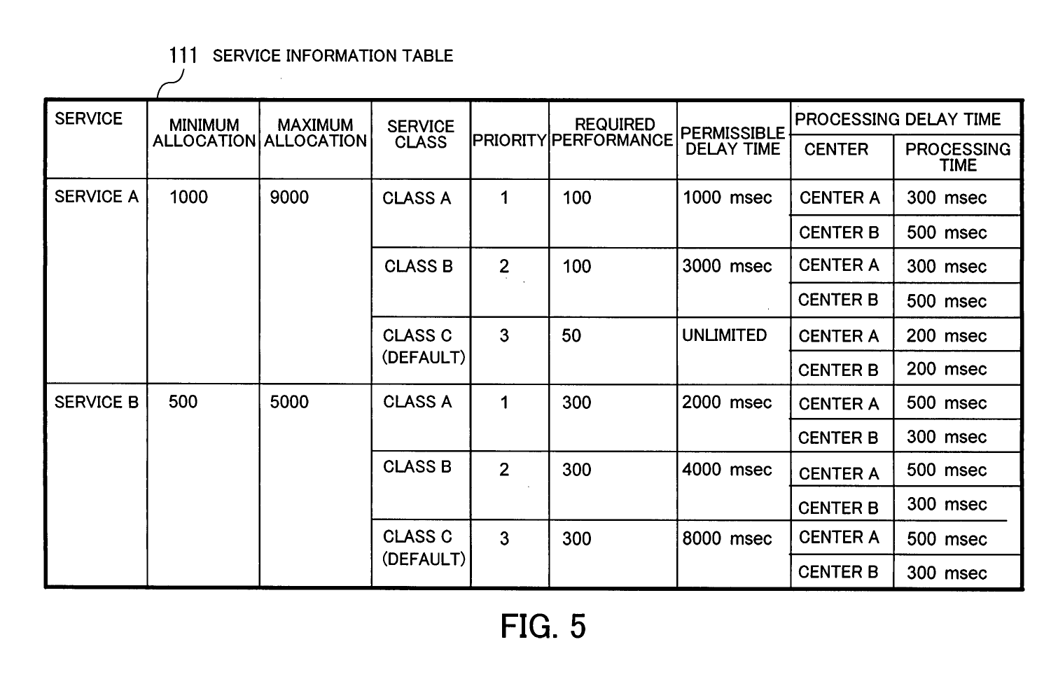

FIG. 5 shows an example of the data structure of the service information table. As shown in FIG. 5, the service information table 111 includes Service, Minimum Allocation, Maximum Allocation, Service Class, Priority, Required Performance, Permissible Delay Time, and Processing Delay Time columns.

A name (service name) for uniquely identifying a service is set in the Service column. A numeric value indicative of the lower limit of a resource quantity (performance) which can be allocated to a corresponding service is set in the Minimum Allocation column. Performance is indicated by, for example, the number of times the processing capability of a computer having a predetermined hardware configuration. A numeric value indicative of the upper limit of a resource quantity which can be allocated to a corresponding service is set in the Maximum Allocation column.

One or more classes which are set for a corresponding service and which indicate quality classification are set in the Service Class column. One of the classes set in the Service Class column is set as the default. If a service class is not specified as a user attribute, then the default class is allocated.

A numeric value indicative of the priority of a corresponding class is set in the Priority column. A smaller numeric value indicates a higher priority. Performance required to provide a service to one user who belongs to a corresponding class is set in the Required Performance column. Delay time permissible to a user who belongs to a corresponding class (delay time guaranteed under a contract with a user) is set in the Permissible Delay Time column. In this case, delay time is time which elapses after a client used by the user outputs a request and before a processing result corresponding to the request reaches the client. That is to say, a value set as delay time includes a transmission delay on a network.

Actual processing time on a server in each data center taken to perform a service corresponding to each class is set in the Processing Delay Time column. Performance (required performance) allocated to perform a service differs among different classes, so processing time also differs among different classes.

All the parameters included in the service information table 111 are set at the time of the start of a service. The Minimum Allocation, Maximum Allocation, and Required Performance parameters can be considered as server performance normalized by using appropriate standards. A Processing Time parameter may be set statically in the initial state or may be determined dynamically and updated.

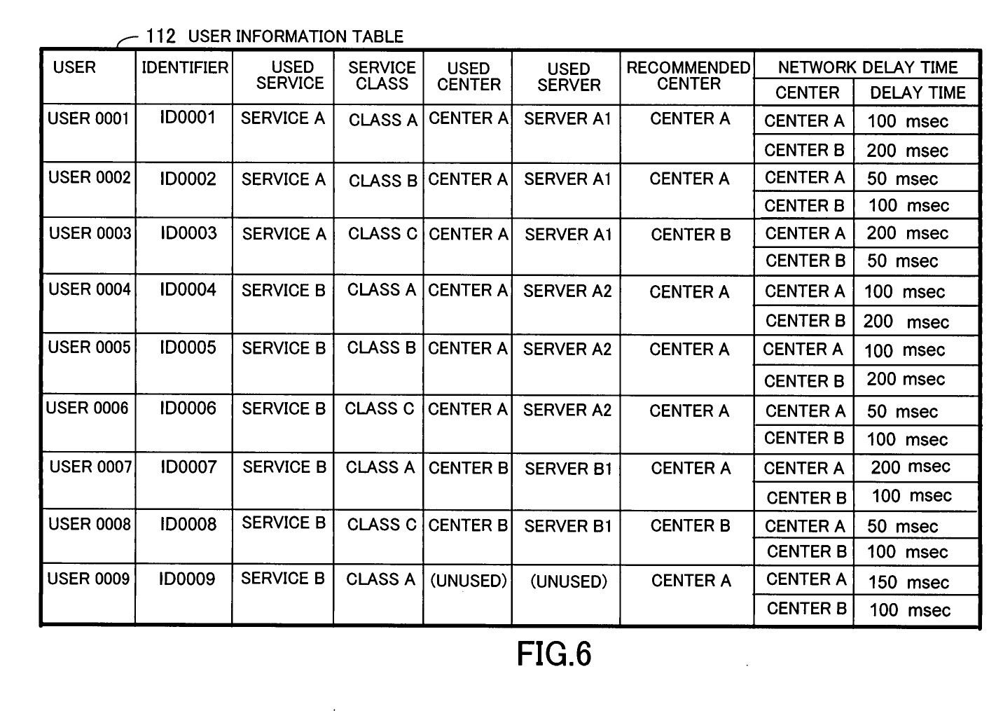

FIG. 6 shows an example of the data structure of the user information table. The user information table 112 includes User, Identifier, Used Service, Service Class, Used Center, Used Server, Recommended Center, and Network Delay Time columns.

Information (user name) for identifying a user who uses a service is set in the User column. An identifier (user ID) for uniquely identifying a user in a system is set in the Identifier column. The name of a service used by a corresponding user is set in the Used Service column. A class of a service used by a user is set in the Service Class column.

The name of a data center (used center) currently used by a corresponding user is set in the Used Center column. The name of a server (used server) currently used by a corresponding user is set in the Used Server column. The name of a data center which is considered to be suitable for a corresponding user's use is set in the Recommended Center column. Delay time on a network at the time of accessing each data center is set in the Network Delay Time column.

After the user information table 112 is set in the wide area load distribution apparatus 100, copies of the user information table 112 are passed to the related intra-center load distribution units. Information is set in the User, Identifier, Used Service, and Service Class columns at the time of the start of a service. Information is set in the Used Center, Used Server, Recommended Center, and Network Delay Time columns at the time of access by a user and is removed from these columns at the time of the end of the use of a service.

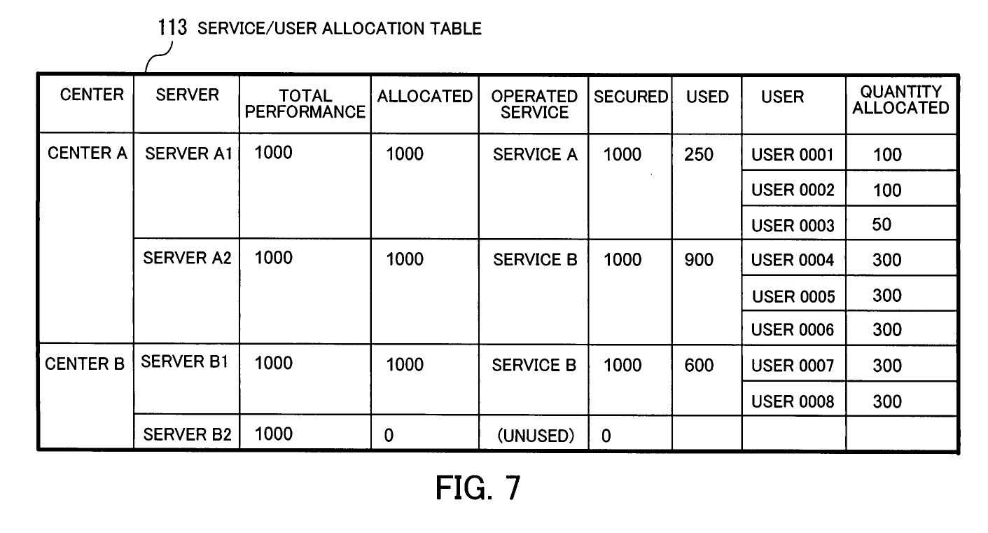

FIG. 7 shows an example of the data structure of the service/user allocation table. The service/user allocation table 113 includes Center, Server, Total Performance, Allocated, Operated Service, Secured, Used, User, and Quantity Allocated columns.

The name of a data center is set in the Center column. The name of a server installed in each data center is set in the Server column. The performance of each server is set in the Total Performance column. Performance allocated to a service performed by each server is set in the Allocated column. The name of a service provided by a corresponding server is set in the Operated Service column. The performance of a server secured to provide a corresponding service is set in the Secured column. Performance used by a user of performance allocated to a service is set in the Used column. The user ID of a user who uses a corresponding server is set in the User column. Performance allocated to provide a service to a corresponding user is set in the Quantity Allocated column.

Information is set in the Center, Server, and Total Performance columns in the service/user allocation table 113 at the time of the start of a service. Information is set in the Allocated, Operated Service, and Secured columns at the time of allocating a service. Information in the Used, User, and Quantity Allocated columns is updated at the time of allocating to a user or moving a user.

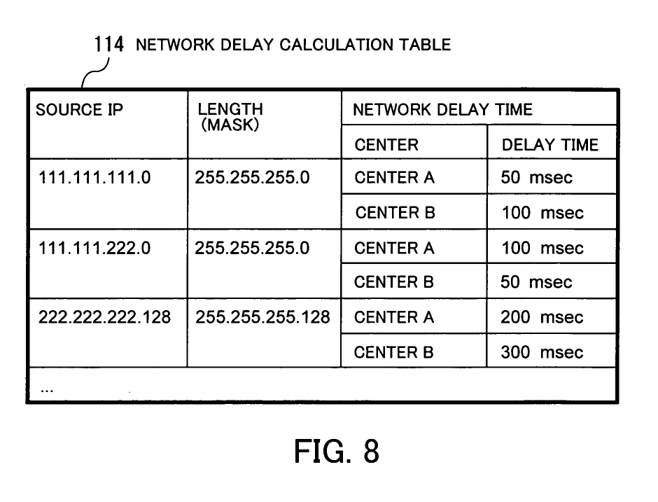

FIG. 8 shows an example of the data structure of the network delay calculation table. The network delay calculation table 114 includes Source IP, Length (Mask), and Network Delay Time columns. The IP address of a server which is installed in an Internet service provider (ISP) for connecting clients is set in the Source IP column. The length of a subnet mask for the server installed in the ISP is set in the Length (Mask) column. Delay time on a network between the server installed in the ISP and each data center is set in the Network Delay Time column.

Information is set in each column in network delay calculation table 114 at start time. While a service is providing, the information set is dynamically updated by, for example, performing determination.

The wide area load distribution apparatus 100 sets information for predetermined items in the service management DB 110 at the time of the beginning of providing a service. In addition, the wide area load distribution apparatus 100 sets information which is included in the user information table 112 and the service/user allocation table 113 and which applies to the data centers 200, 300, and 400 in the corresponding intra-center load distribution units 210, 310, and 410. The wide area load distribution apparatus 100 also sets information which is included in the service/user allocation table 113 and which applies to each server in the server.

The wide area load distribution apparatus 100 having the above function and information takes the initiative in performing load distribution and a service is provided to a client. A load distribution process performed to provide a service will now be described in detail.

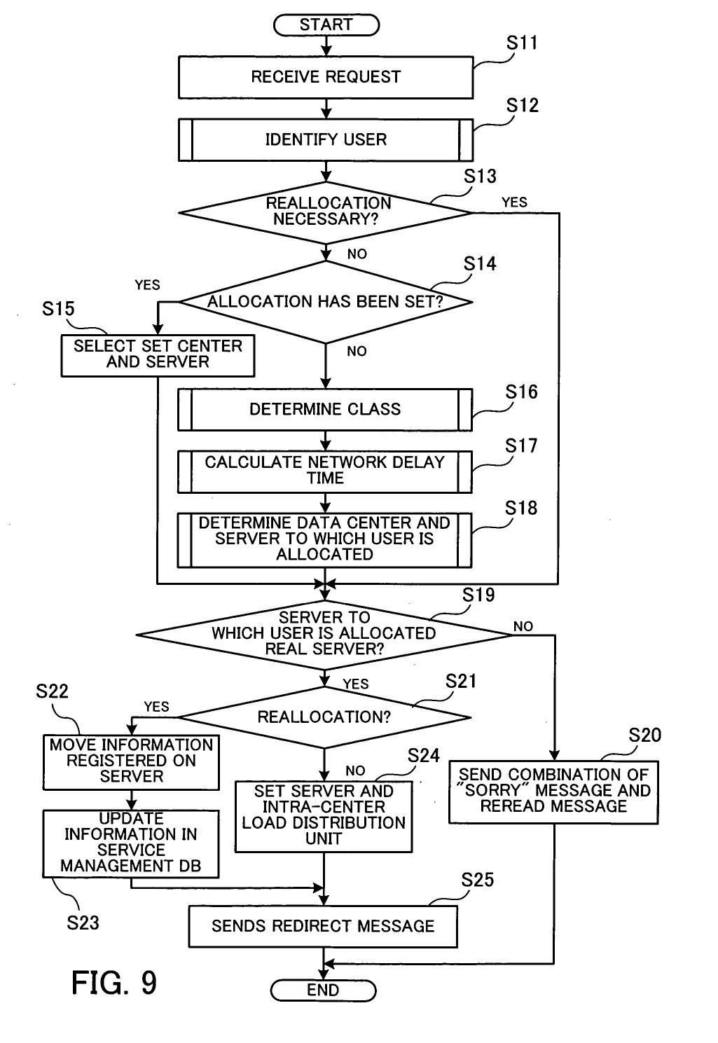

FIG. 9 is a flow chart showing the procedure for a process performed by the wide area load distribution apparatus. The process shown in FIG. 9 will now be described in order of step number.

[Step S11] The request allocation control section 121 included in the wide area load distribution apparatus 100 receives a request from a client.

[Step S12] The request allocation control section 121 requests the user identification section 122 to identify a user. The user identification section 122 then extracts a user ID from the request. The request allocation control section 121 receives the user ID from the user identification section 122.

[Step S13] The request allocation control section 121 determines whether the reallocation of the user is necessary. Whether or not the user is reallocated depends on whether a reallocation condition set in advance in the request allocation control section 121 is met. For example, even if the user is allocated once to a server, allocation can forcedly be reconsidered at predetermined time intervals. In this case, the predetermined time intervals at which reconsideration is given are set as a reallocation condition. Therefore, on the basis of whether the predetermined time has elapsed after the user who outputted the request was allocated the last time, the request allocation control section 121 determines whether reallocation is necessary.

If the user outputs the request for the first time, then the request allocation control section 121 determines that reallocation is unnecessary. If reallocation is necessary, then step S19 is performed. If reallocation is unnecessary, then step S14 is performed.

[Step S14] The request allocation control section 121 determines whether a data center and a server to which the user is to be allocated have been set. To be concrete, the request allocation control section 121 refers to the user information table 112, searches the user ID of the user who outputted the request, and determines whether a used center and a used server are registered. If a used center and a used server are registered, then the request allocation control section 121 determines that a data center and a server to which the user is to be allocated have been set. If a data center and a server to which the user is to be allocated have been set, then step S15 is performed. If a data center and a server to which the user is to be allocated have not been set yet, then step S16 is performed.

[Step S15] The request allocation control section 121 selects the used center and the used server which are associated with the user ID of the user who outputted the request and which are registered from the user information table 112. Step S19 is then performed.

[Step S16] The request allocation control section 121 requests the class determination section 123 to determine a class of the user for a service. The request allocation control section 121 then obtains information indicative of the class from the class determination section 123.

[Step S17] The request allocation control section 121 requests the network delay calculation section 124 to calculate network delay time. The request allocation control section 121 then obtains the network delay time from the network delay calculation section 124.

[Step S18] The request allocation control section 121 requests the allocation determination section 125 to determine a data center and a server to which the user is allocated. The request allocation control section 121 then obtains the names of the data center and the server from the allocation determination section 125.

[Step S19] The request allocation control section 121 determines whether the server to which the user is allocated is a real server. If in step S18 the request allocation control section 121 obtains the names of the data center and the server which really exist, then the server to which the user is allocated is a real server. If in step S18 the request allocation control section 121 obtains empty data (or a message indicative of nonexistence) as the names of the data center and the server, then the server to which the user is allocated is not a real server. If the server to which the user is allocated is a real server, then step S21 is performed. If the server to which the user is allocated is not a real server, then step S20 is performed.

[Step S20] The request allocation control section 121 sends the client a combination of a “sorry” message (which indicates that the user cannot be allocated to a server) and a reread message (which requests the user to output a request after specified time) and terminates the process.

[Step S21] The request allocation control section 121 determines whether the allocation of the server to the user is reallocation. If the request allocation control section 121 determines in step S14 that allocation has been set, then the allocation of the server to the user is reallocation. If the allocation of the server to the user is reallocation, then step S22 is performed. If the allocation of the server to the user is not reallocation, then step S24 is performed.

[Step S22] The request allocation control section 121 moves all information regarding the user in question (user who outputted the request) registered on the original server to a server to which the user is moved.

[Step S23] The request allocation control section 121 updates information in the service management DB 110 with a change in the server to which the user is allocated. To be concrete, the request allocation control section 121 updates information in the Used Center, Used Server, and Recommended Center columns in the user information table 112 corresponding to the user in question. In addition, the request allocation control section 121 updates information regarding the user registered on an intra-center load distribution unit in a data center from which the user is moved and an intra-center load distribution unit in a data center to which the user is moved. Step S25 is then performed.

[Step S24] The request allocation control section 121 sets the server in the data center to which the user is allocated and the intra-center load distribution unit in the data center.

[Step S25] The request allocation control section 121 sends the client a redirect message for giving instructions to send a request to the data center to which the user is allocated.

In summary, when the request is sent from the client, the wide area load distribution apparatus 100 determines the data center and the server to which the user is allocated. If there is a change in the server to which the user is allocated, then the wide area load distribution apparatus 100 gives instructions to move information between the servers and to change information registered on the intra-center load distribution units. When the wide area load distribution apparatus 100 determines the data center and the server to which the user is allocated, the wide area load distribution apparatus 100 sends the client the redirect message including the data center to which the user is allocated. If the wide area load distribution apparatus 100 cannot determine a data center and a server to which the user is allocated, then the wide area load distribution apparatus 100 returns the message for giving instructions to reread after specified time to the client.

A user identification process will now be described in detail.

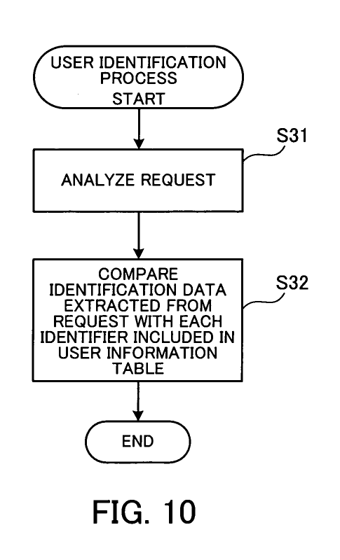

FIG. 10 is a flow chart showing the procedure for a user identification process. The process shown in FIG. 10 will now be described in order of step number.

[Step S31] In response to the request from the request allocation control section 121, the user identification section 122 analyzes the request sent from the client and extracts the user identification data from the request. If this request is based on, for example, the HTTP, then the user identification data is a character string set as a parameter in a cookie or a request line.

[Step S32] The user identification section 122 compares the identification data extracted from the request with each identifier in the Identifier column included in the user information table 112. The user identification section 122 passes information (user name) in the User column included in a record in which an identifier matches the identification data extracted from the request to the request allocation control section 121.

A user class determination process will now be described in detail.

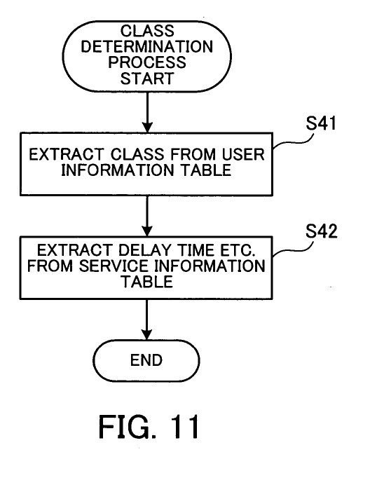

FIG. 11 is a flow chart showing the procedure for a class determination process. The process shown in FIG. 11 will now be described in order of step number.

[Step S41] In response to the request from the request allocation control section 121, the class determination section 123 extracts a class of the user in question from the user information table 112. To be concrete, the class determination section 123 searches the user information table 112 for a record including the user name obtained by the user identification section 122, obtains a service name from the Used Service column included in the record, and obtains a class name from the Service Class column included in the record.

[Step S42] The class determination section 123 extracts various pieces of information (such as processing delay time) associated with the service and the service class extracted in step S41 from the service information table 111. The class determination section 123 then passes the information extracted in steps S41 and S42 to the request allocation control section 121.

In summary, the class allocated to the user and the information regarding the class are obtained. If a class is not allocated to the user in the user information table 112, then information regarding a class specified as the default is extracted from the service information table 111.

A network delay calculation process will now be described in detail.

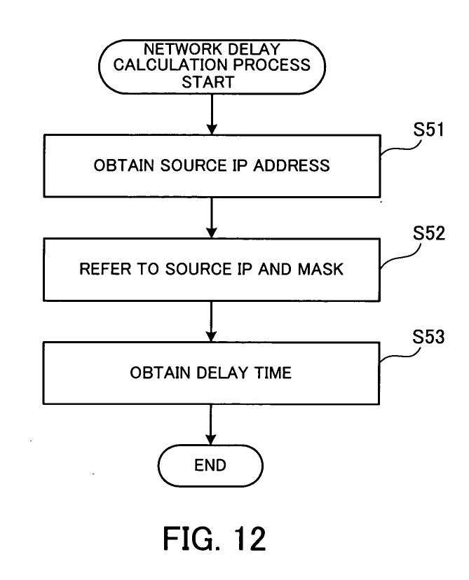

FIG. 12 is a flow chart showing the procedure for a network delay calculation process. The process shown in FIG. 12 will now be described in order of step number.

[Step S51] In response to the request from the request allocation control section 121, the network delay calculation section 124 obtains a source IP address from the request. That is to say, an IP address of the client is obtained.

[Step S52] The network delay calculation section 124 refers to the Source IP and Length (Mask) columns included in the network delay calculation table 114 and specifies a record corresponding a server which accommodates the client. To be concrete, the network delay calculation section 124 specifies a network address part of a source IP included in the network delay calculation table 114 by a subnet mask set in the Length (Mask) column. The network delay calculation section 124 then compares the network address of each server with a corresponding part of the IP address of the client. The network delay calculation section 124 specifies a server the network address of which matches the corresponding part of the IP address of the client as a server which accommodates the client.

[Step S53] The network delay calculation section 124 obtains delay time on a network between the server which accommodates the client which sent the request and each data center from the network delay calculation table 114. The network delay calculation section 124 then passes the delay time obtained to the request allocation control section 121.

In summary, on the basis of the IP address of the client which sent the request, a communication delay which occurs between the client and each data center can be calculated.

An allocation determination process will now be described in detail.

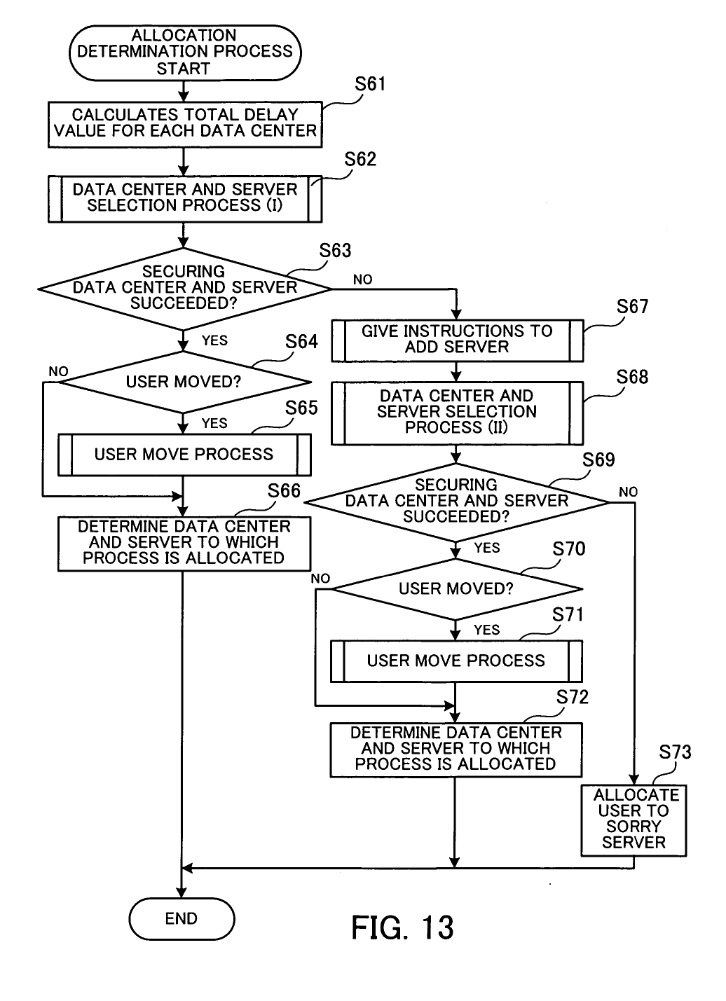

FIG. 13 is a flow chart showing the procedure for an allocation determination process. The process shown in FIG. 13 will now be described in order of step number.

[Step S61] In response to the request from the request allocation control section 121, the allocation determination section 125 calculates a total delay value for each data center. A total delay value is obtained by adding up network delay time and processing delay time.

[Step S62] On the basis of the total delay value, the allocation determination section 125 performs the process of selecting a data center and a server to which a process should be allocated. In this selection process, a data center and a server by which permissible delay time corresponding to the user class is guaranteed are selected. To be concrete, the allocation determination section 125 requests the server selection section 126 to select a server.

[Step S63] The allocation determination section 125 determines whether or not securing a data center and a server to which the process is allocated succeeded. If securing a data center and a server to which the process is allocated succeeded, then step S64 is performed. If securing a data center and a server to which the process is allocated did not succeed, then step S67 is performed.

[Step S64] The allocation determination section 125 determines whether the user is moved. Moving the user means that a higher priority user is allocated to the data center and the server. The reason for this is that a resource to be allocated to a lower priority user is exhausted. In this case, it is necessary to move the lower priority user to another data center and server.

If the user is moved, then step S65 is performed. If the user is not moved, then step S66 is performed.

[Step S65] The allocation determination section 125 requests the user move section 127 to perform a user move process.

[Step S66] The allocation determination section 125 determines the data center and the server selected in step S62 as a data center and a server to which the process is allocated. After that the process terminates.

[Step S67] The allocation determination section 125 gives the management server 50 instructions to add a server. The allocation determination section 125 proceeds to step S68 without waiting for a response from the management server 50 which informs that the addition of a server is completed.

[Step S68] The allocation determination section 125 performs the process of selecting a data center and a server to which the process should be allocated. In this selection process, the permissible delay time corresponding to the user class is not guaranteed. To be concrete, the allocation determination section 125 requests the server selection section 126 to select a server.

[Step S69] The allocation determination section 125 determines whether or not securing a data center and a server to which the process is allocated succeeded. If securing a data center and a server to which the process is allocated succeeded, then step S70 is performed. If securing a data center and a server to which the process is allocated did not succeed, then step S73 is performed.

[Step S70] The allocation determination section 125 determines whether the user is moved. If the user is moved, then step S71 is performed. If the user is not moved, then step S72 is performed.

[Step S71] The allocation determination section 125 requests the user move section 127 to perform a user move process.

[Step S72] The allocation determination section 125 determines the data center and the server selected in step S68 as a data center and a server to which the process is allocated. At this time the allocation determination section 125 registers the data center selected in step S62 in the user information table 112 as a recommended center. After that the process terminates.

[Step S73] If the allocation determination section 125 determines in step S69 that securing a data center and a server to which the process is allocated did not succeed, then the allocation determination section 125 allocates the user to a “sorry” server (virtual server defined when a “sorry” message is returned).

In summary, on the basis of a total processing delay value for the user calculated from delay values as class information and user information, a data center by which a delay becomes smaller than or equal to the guaranteed value and in which capacity can be secured is searched for. If a data center which meets these conditions is found, then this data center is designated as a data center to which the user is allocated.

If a data center which meets these conditions is not found, then the determination that the system is in a state in which a service of good quality cannot be provided to the user is made and a server is added on demand. By doing so, an attempt to provide the service of good quality is made. In this case, it takes some time to add the server. Therefore, a data center used for performing a process before completing the addition of the server is searched for. If such a data center is found, then the user is allocated temporarily to the data center (the user will be moved to a recommended server by rearrangement performed later. If at this stage the user cannot be allocated to a server because of a lack of resources, then the “sorry” response is returned.

A server addition process performed by the management server 50 in accordance with the instructions to add a server will now be described.

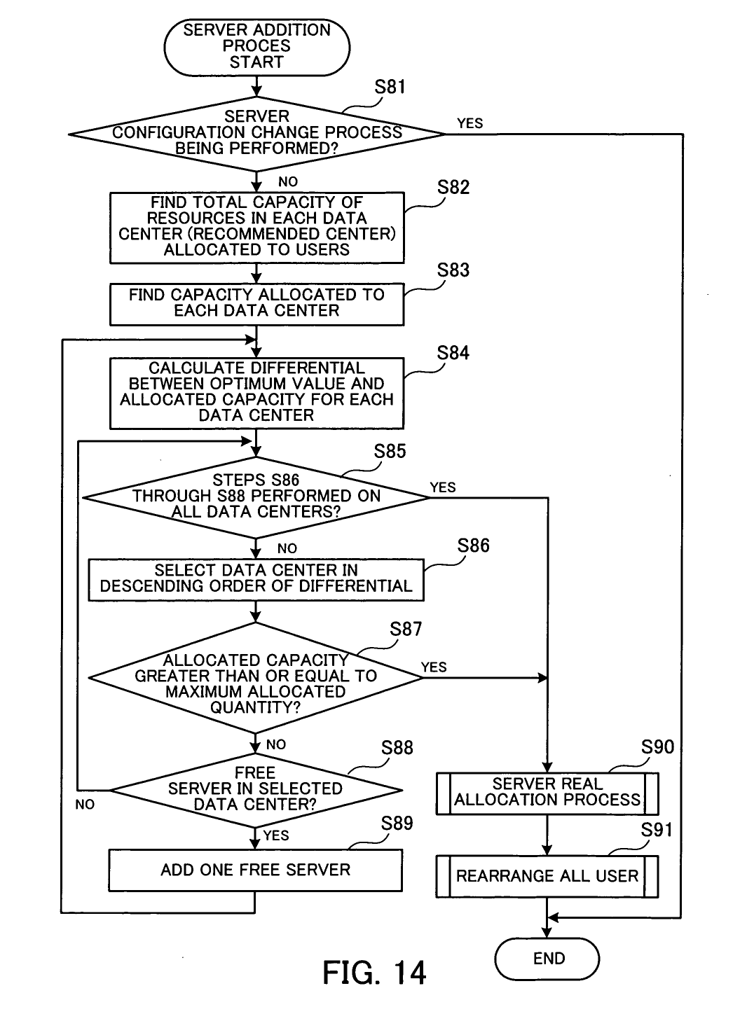

FIG. 14 is a flow chart showing the procedure for a server addition process. The process shown in FIG. 14 will now be described in order of step number.

[Step S81] When the management server 50 receives the instructions to add a server from the wide area load distribution apparatus 100, the management server 50 determines whether a server configuration change process is being performed. If a server configuration change process is being performed, a server is added by this process. Accordingly, a process corresponding to the request from the management server 50 terminates. If a server configuration change process is not being performed, then step S82 is performed.

[Step S82] The management server 50 refers to the user information table 112 the wide area load distribution apparatus 100 has, obtains a data center (recommended center) most suitable for each user, and finds the total capacity (optimum value) of resources in each data center (recommended center) allocated to users.

[Step S83] The management server 50 refers to the service/user allocation table 113 the wide area load distribution apparatus 100 has, and finds a resource quantity (allocated capacity) allocated to each data center. A resource quantity allocated is the total of allocated performance values of servers installed in each data center.

[Step S84] The management server 50 calculates the differential between the optimum value and the allocated capacity for each data center.

[Step S85] The management server 50 determines whether steps S86 through S88 have been performed on all the data centers. If steps S86 through S88 have been performed on all the data centers, then step S90 is performed. If there is a data center on which steps S86 through S88 have not been performed yet, then step S86 is performed.

[Step S86] The management server 50 selects a data center in descending order of differential between optimum value and allocated capacity.

[Step S87] The management server 50 refers to the service/user allocation table 113 and determines whether allocated capacity for the selected data center is greater than or equal to a maximum allocated quantity. That is to say, the management server 50 determines whether resources allocated to the selected data center are sufficient to allocate all of the users for whom the selected data center is a recommended center. If the allocated capacity is greater than or equal to the maximum allocated quantity, then step S90 is performed. If the allocated capacity is smaller than the maximum allocated quantity, then step S88 is performed.

[Step S88] The management server 50 determines whether there is a free server (server for which a value in the Allocated column in the service/user allocation table 113 is smaller than a value in the Total Performance column) in the selected data center. If there is a free server in the selected data center, then step S89 is performed. If there is no free server in the selected data center, then step S85 is performed.

[Step S89] The management server 50 adds one free server to the selected data center. That is to say, the resource quantity allocated to the selected data center is increased. Step S83 is then performed to recalculate allocated capacity.

[Step S90] The management server 50 performs a server real allocation process.

[Step S91] The management server 50 performs a rearrangement process on all the users. After that the process terminates.

In summary, after the determination that the process of adding or removing a server is not being performed is made, a data center most suitable for each of the users who currently use the system is examined and an allocated quantity needed in an optimum state in each data center is calculated. In addition, a resource quantity currently allocated to each data center is calculated. To secure a necessary resource quantity, a data center is selected as a candidate to which a server is added in descending order of differential between optimum value and resource quantity allocated. After that, server allocation and the rearrangement of all the user are really performed.

A center and server selection process (I) in which delay is guaranteed will now be described in detail.

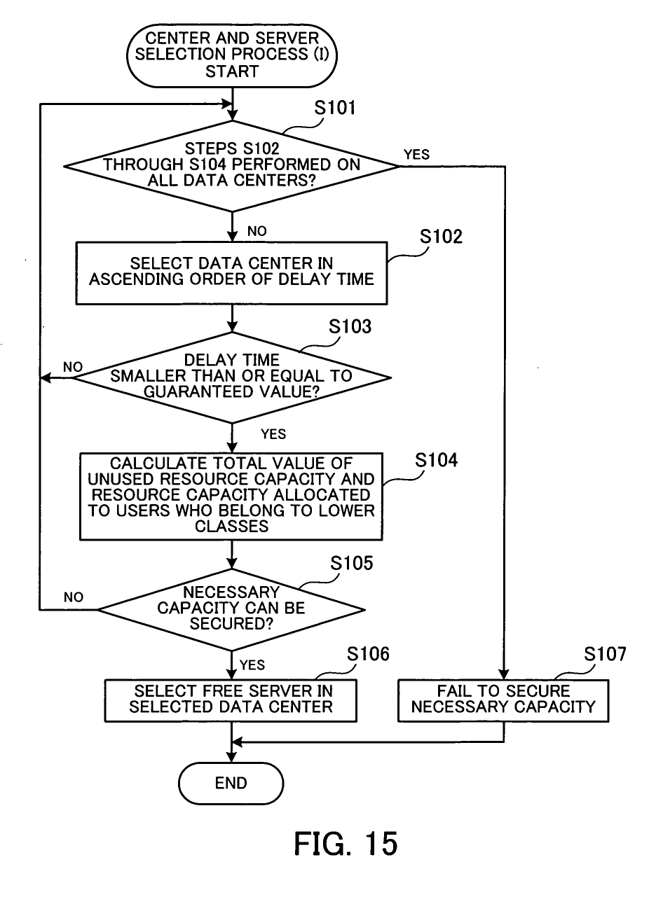

FIG. 15 is a flow chart showing the procedure for a center and server selection process (I). The process shown in FIG. 15 will now be described in order of step number.

[Step S101] The server selection section 126 determines whether steps S102 through S104 have been performed on all the data centers. If steps S102 through S104 have been performed on all the data centers, then step S107 is performed. If there is a data center on which steps S102 through S104 have not been performed yet, then step S102 is performed.

[Step S102] The server selection section 126 selects a data center in ascending order of delay time.

[Step S103] The server selection section 126 determines whether delay time for the selected data center is smaller than or equal to a guaranteed value. If the delay time is smaller than or equal to the guaranteed value (total delay time is smaller than or equal to the permissible delay time), then step S104 is performed. If the delay time is greater than the guaranteed value, then step S101 is performed.

[Step S104] The server selection section 126 calculates the total value of unused resource capacity and resource capacity allocated to users who belong to classes lower in priority than that of the user to be currently allocated.

[Step S105] On the basis of whether the value obtained in step S104 is greater than or equal to resource capacity which must be allocated to the user in response to the request, the server selection section 126 determines whether necessary capacity can be secured. If the necessary capacity can be secured, then step S106 is performed. If the necessary capacity cannot be secured, then step S101 is performed to examine another data center.

[Step S106] The server selection section 126 selects a free server in the selected data center as a resource to be allocated to the user. The server selection section 126 then passes information regarding the selected data center and server to the allocation determination section 125 (to the user move section 127 if a user move process is being performed). If a resource allocated to users who belong to lower classes must be diverted, then the server selection section 126 registers these users in a moved user list as users to be moved. After that the process terminates.

[Step S107] If the server selection section 126 examines all the data centers and cannot detect a data center in which the necessary capacity can be secured, then the server selection section 126 passes a message indicative of a failure to secure the necessary capacity to the allocation determination section 125 (to the user move section 127 if a user move process is being performed).

In summary, a data center for which a delay value as seen from the user is smaller than or equal to the guaranteed value and with which a service can be provided to the user to be currently allocated by using an unused resource and a resource allocated to users who belong to classes lower in priority than that of the user to be currently allocated is searched for. If an appropriate data center is found, then a server in this data center is selected as a server to which the user is to be allocated.

A center and server selection process (II) in which delay is not guaranteed will now be described in detail.

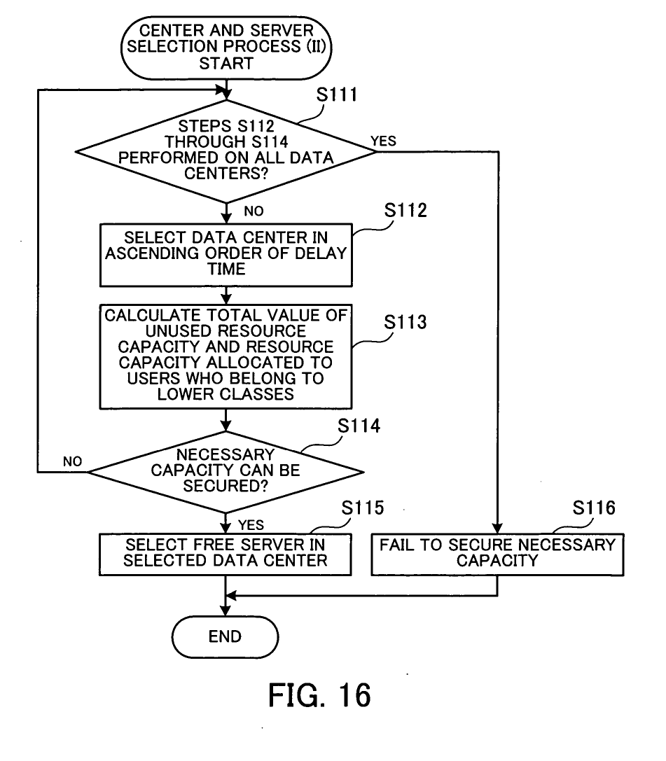

FIG. 16 is a flow chart showing the procedure for a center and server selection process (II). The process shown in FIG. 16 will now be described in order of step number.

[Step S111] The server selection section 126 determines whether steps S112 through S114 have been performed on all the data centers. If steps S112 through S114 have been performed on all the data centers, then step S116 is performed. If there is a data center on which steps S112 through S114 have not been performed yet, then step S112 is performed.

[Step S112] The server selection section 126 selects a data center in ascending order of delay time.

[Step S113] The server selection section 126 calculates the total value of unused resource capacity and resource capacity allocated to users who belong to classes lower in priority than that of the user to be currently allocated.

[Step S114] On the basis of whether the value obtained in step S113 is greater than or equal to resource capacity which must be allocated to the user in response to the request, the server selection section 126 determines whether necessary capacity can be secured. If the necessary capacity can be secured, then step S115 is performed. If the necessary capacity cannot be secured, then step S111 is performed to examine another data center.

[Step S115] The server selection section 126 selects a free server in the selected data center as a resource to be allocated to the user. The server selection section 126 then passes information regarding the selected data center and server to the allocation determination section 125 (to the user move section 127 if a user move process is being performed). If a resource allocated to users who belong to lower classes must be diverted, then the server selection section 126 registers these users in a moved user list as users to be moved. After that the process terminates.

[Step S116] If the server selection section 126 examines all the data centers and cannot detect a data center in which the necessary capacity can be secured, then the server selection section 126 passes a message indicative of a failure to secure the necessary capacity to the allocation determination section 125 (to the user move section 127 if a user move process is being performed).

In summary, if delay is not guaranteed, a data center and a server which can provide a service are selected regardless of whether the quality of the service is smaller than or equal to a guaranteed value.

A user move process will now be described.

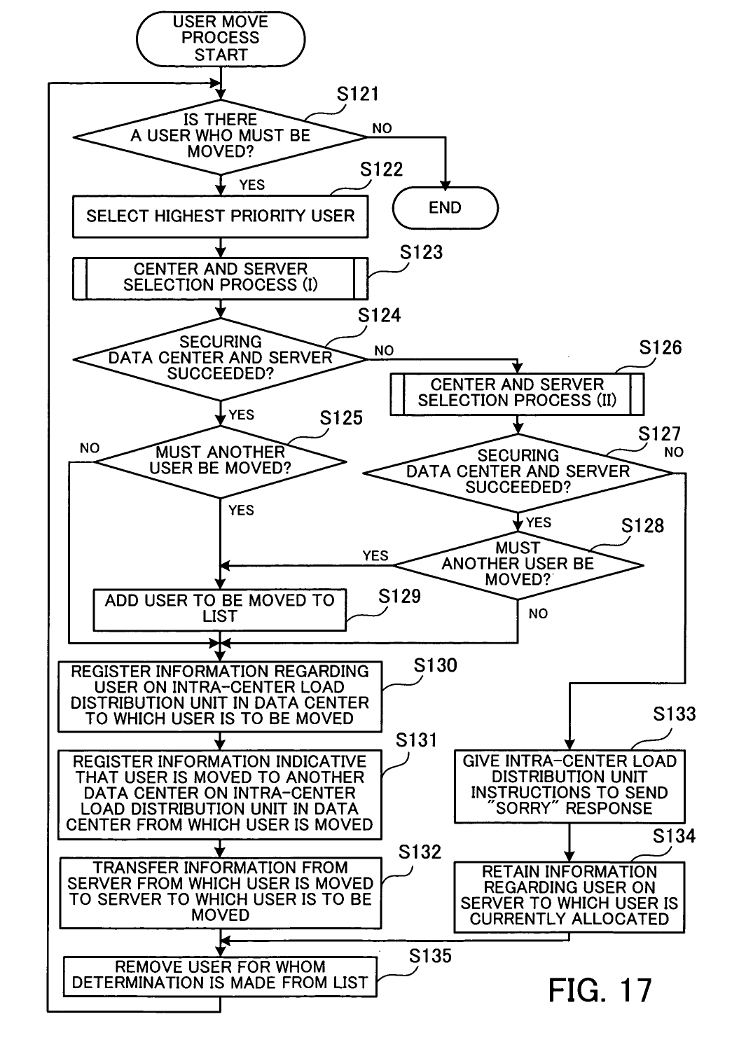

FIG. 17 is a flow chart showing the procedure for a user move process. The process shown in FIG. 17 will now be described in order of step number.

[Step S121] In response to the request from the allocation determination section 125, the user move section 127 determines whether there is a user who must be moved and who has not been moved yet. A user who must be moved is registered in the moved user list as the one to be moved. If there is a user who must be moved, then step S122 is performed. If there is no user that must be moved, then the process terminates.

[Step S122] The user move section 127 selects the highest priority user from among users who must be moved.

[Step S123] The user move section 127 requests the server selection section 126 to perform a center and server selection process by which delay is guaranteed.

[Step S124] The user move section 127 determines whether securing a data center and a server succeeded in the process performed in step S123. If a data center and a server can be secured, then step S125 is performed. If a data center or a server cannot be secured, then step S126 is performed.

[Step S125] The user move section 127 determines whether another user must be moved. If another user must be moved, then step S129 is performed. If another user need not be moved, then step S130 is performed.

[Step S126] If a data center and a server with which delay is guaranteed cannot be secured, then the user move section 127 requests the server selection section 126 to perform a center and server selection process by which delay is not guaranteed.

[Step S127] The user move section 127 determines whether securing a data center and a server succeeded in the process performed in step S126. If a data center and a server can be secured, then step S128 is performed. If a data center or a server cannot be secured, then step S133 is performed.

[Step S128] The user move section 127 determines whether another user must be moved. If another user must be moved, then step S129 is performed. If another user need not be moved, then step S130 is performed.

[Step S129] If another user must be moved, then the user move section 127 adds this user to the moved user list.

[Step S130] The user move section 127 registers information regarding the user to be moved on an intra-center load distribution unit in a data center to which the user is to be moved.

[Step S131] The user move section 127 registers information indicative that the user to be moved is moved to another data center on an intra-center load distribution unit in a data center from which the user is moved.

[Step S132] The user move section 127 gives a server from which the user to be moved is moved and a server to which the user to be moved is moved the instructions that the server from which the user to be moved is moved should transfer information regarding the user to be moved (information required to take over a service) to the server to which the user to be moved is moved. In this case, the server from which the user to be moved is moved is set so that it will return a message for giving instructions to reaccess the wide area load distribution apparatus 100 in the case of the next request from the client used by the user being made. By doing so, access from the client is transferred to the wide area load distribution apparatus 100 and the request is allocated to the data center to which the user to be moved is moved. Step S135 is then performed.

[Step S133] The user move section 127 gives the intra-center load distribution unit in the data center to which the user to be moved is currently allocated instructions to send a “sorry” response to the client used by the user.

[Step S134] The user move section 127 gives the server to which the user to be moved is currently allocated instructions to retain the information regarding the user. Step S135 is then performed.

[Step S135] When the data center and the server to which the user is to be moved are determined, the user move section 127 removes the user from the moved user list. Step S121 is then performed.

In summary, a server move process is performed on each of users who must be moved in descending order of user class level. If a server by which delay time can be guaranteed can be selected, then the server is preferentially selected. If there is no server that delay time can be guaranteed by, then a data center in which a resource can be secured is selected. In this case, the guaranteed delay value is not satisfied. If a server which satisfies the guaranteed delay value or a server which does not satisfy the guaranteed delay value cannot be selected, then instructions to return a “sorry” response are given.

To move a user to a new data center, the server from which the user is to be moved is set so that it will return a message for giving instructions to reaccess the wide area load distribution apparatus 100 in the case of the next request from the user being made. In addition, information regarding the user retained on the server from which the user is to be moved is moved to a server to which the user is to be moved. Furthermore, information regarding the user to be moved registered on the intra-center load distribution unit in the data center from which the user is to be moved is updated and information regarding the user to be moved is registered on the intra-center load distribution unit in the data center to which the user is to be moved. If another user must be moved as a result of the above user move process, then this user to be moved is added to the moved user list. The process shown in FIG. 17 is repeated until data centers and servers to which all users are moved are determined.

An all user rearrangement process will now be described in detail.

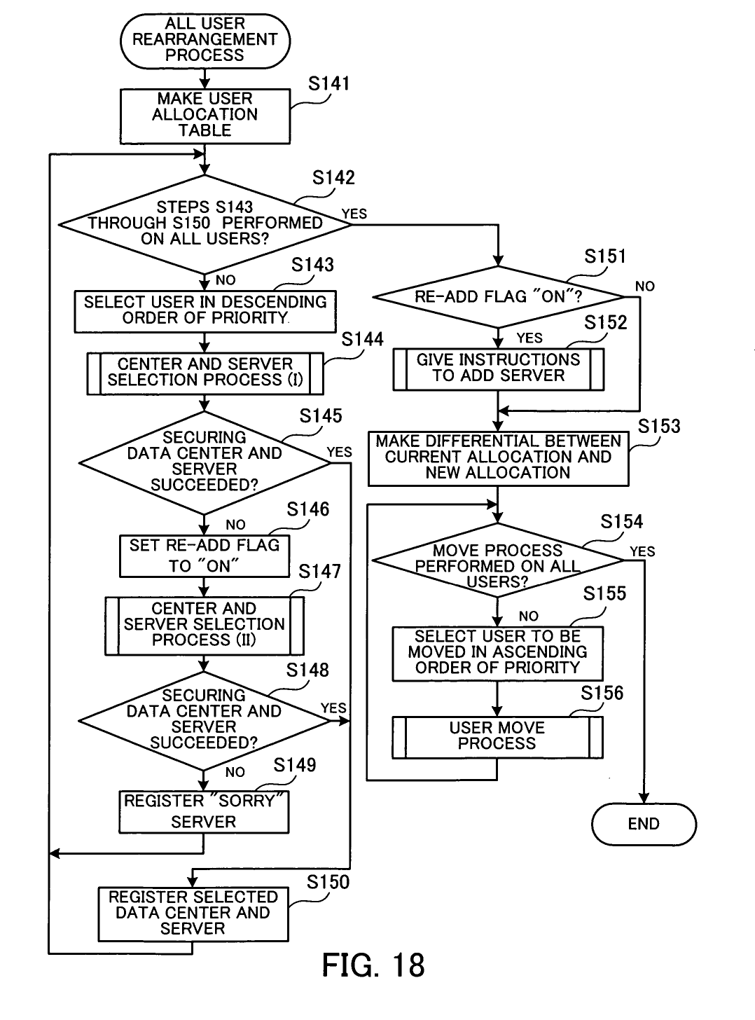

FIG. 18 is a flow chart showing the procedure for an all user rearrangement process. The process shown in FIG. 18 will now be described in order of step number.

[Step S141] The user move section 127 makes a user allocation table. A data center and a server to which each user is allocated are registered in the user allocation table.

[Step S142] The user move section 127 determines whether steps S143 through S150 have been performed on all the users. If steps S143 through S150 have been performed on all the users, then step S151 is performed. If there is a user on which steps S143 through S150 have not been performed yet, then step S143 is performed.

[Step S143] The user move section 127 selects a user in descending order of priority.

[Step S144] The user move section 127 requests the server selection section 126 to perform a center and server selection process (I) by which delay time is guaranteed.

[Step S145] The user move section 127 determines whether securing a data center and a server succeeded in the process performed in step S144. If a data center and a server can be secured, then step S150 is performed. If a data center or a server cannot be secured, then step S146 is performed.

[Step S146] If a data center or a server cannot be secured, then the user move section 127 sets a re-add flag to “on”.

[Step S147] The user move section 127 requests the server selection section 126 to perform a center and server selection process (II) by which delay time is not guaranteed.

[Step S148] The user move section 127 determines whether securing a data center and a server succeeded in the process performed in step S147. If a data center and a server can be secured, then step S150 is performed. If a data center or a server cannot be secured, then step S149 is performed.

[Step S149] The user move section 127 registers a “sorry” server (which indicates that the allocation failed) in the user allocation table as a server to which the selected user is to be allocated. The user move section 127 then returns to step S142 to perform a process on another user.

[Step S150] The user move section 127 registers the selected data center and server in the user allocation table as a data center and a server to which the selected user is to be allocated. The user move section 127 then returns to step S142 to perform a process on another user.

[Step S151] After allocating data centers and servers to all the users, the user move section 127 determines whether the re-add flag is “on”. If the re-add flag is “on,” then step S152 is performed. If the re-add flag is “off” (initial state), then step S153 is performed.

[Step S152] The user move section 127 gives the management server 50 instructions to add a server.

[Step S153] The user move section 127 makes the differential between a data center and server (current allocation) currently allocated to each user and a data center and server (new allocation) selected for each user in steps S142 through S150. This differential is a list of users for whom the current allocation and the new allocation differ.

[Step S154] The user move section 127 determines whether a move process has been performed on all of the users detected by making the differential. If a move process has been performed on all of the users, then the process terminates. If there is a user on which a move process has not been performed yet, then step S155 is performed.

[Step S155] The user move section 127 selects a user to be moved in ascending order of priority.

[Step S156] The user move section 127 performs a move process on the selected user. Step S154 is then performed.

The allocation of all the user is optimized in this way. That is to say, all the users are allocated to appropriate servers in descending order of priority. If there is a user to whom the guaranteed delay value is not satisfied then a server addition process is performed.

An under- or overcapacity determination process performed by the management server 50 will now be described. The under- or overcapacity determination process is regularly performed to automatically add or remove a server according to excess or deficiency of processing capability.

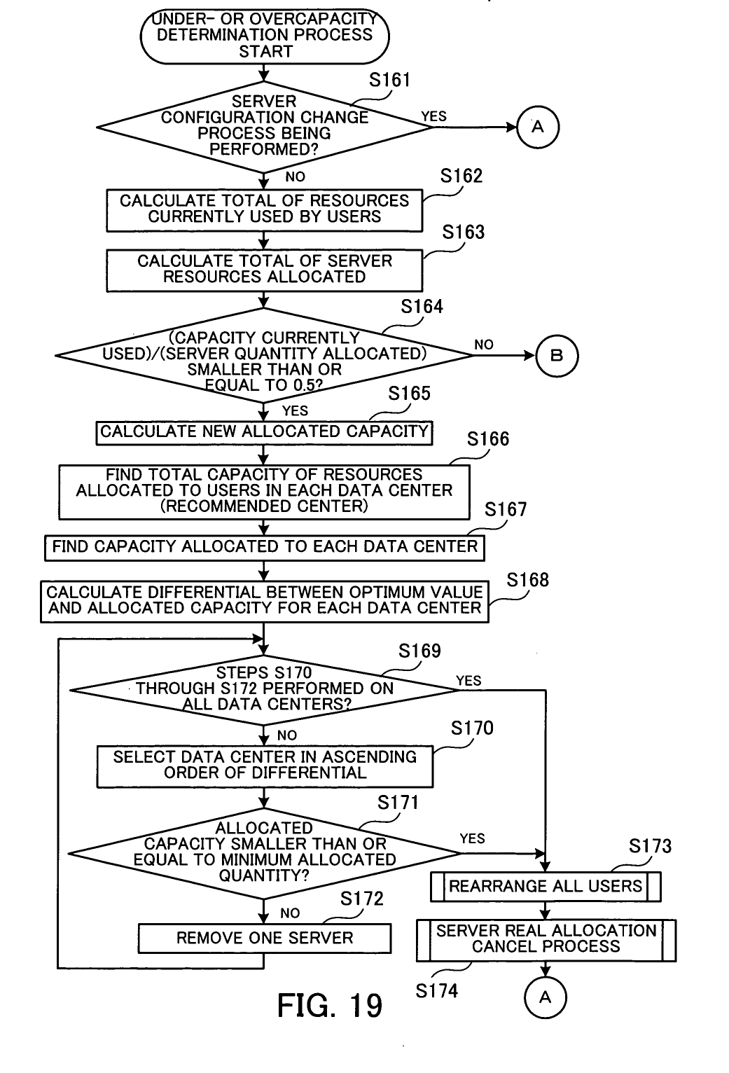

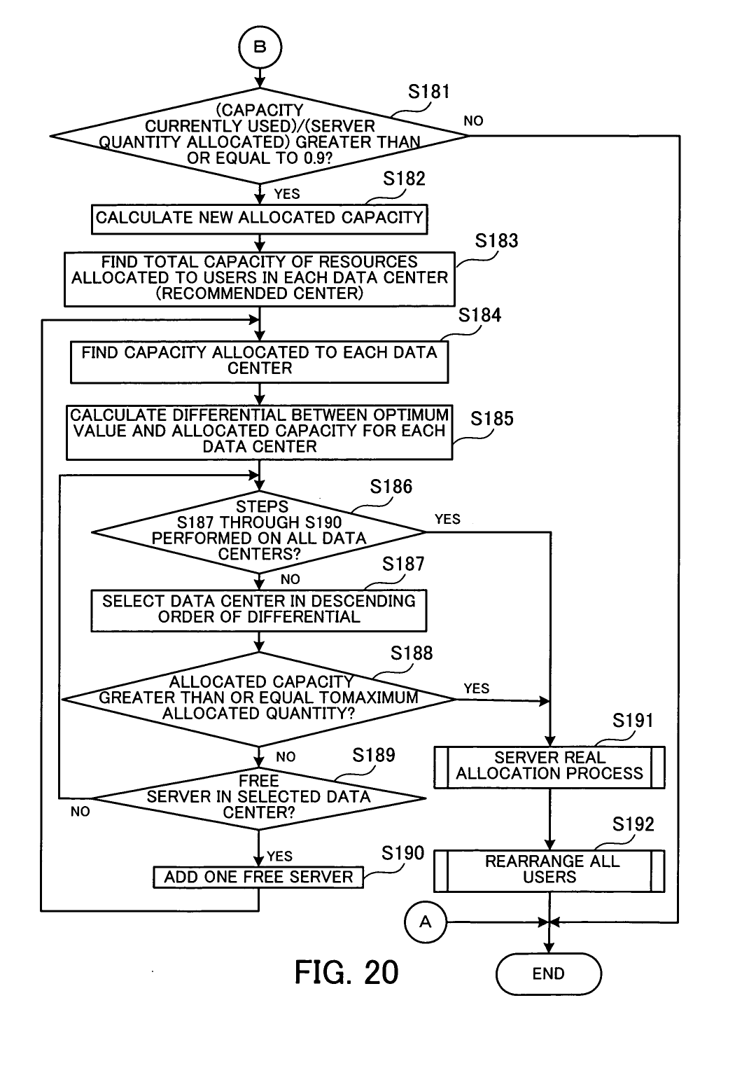

FIG. 19 is the first half of a flow chart showing the procedure for an under- or overcapacity determination process. The process shown in FIG. 19 will now be described in order of step number.

[Step S161] The management server 50 determines whether a server configuration change process is being performed. If a server configuration change process is not being performed, then step S162 is performed. If a server configuration change process is being performed, then the process terminates.

[Step S162] The management server 50 calculates the total (capacity currently used) of resources currently used by users. The resources currently used by users are indicated by values in the Used column in the service/user allocation table 113.

[Step S163] The management server 50 calculates the total (server quantity allocated) of server resources allocated for providing services. The server resources allocated for providing services are indicated by values in the Allocated column in the service/user allocation table 113.

[Step S164] The management server 50 determines whether the value of (capacity currently used)/(server quantity allocated) is smaller than or equal to 0.5 (usage is not greater than 50%). If the value of (capacity currently used)/(server quantity allocated) is smaller than or equal to 0.5, then step S165 is performed. If the value of (capacity currently used)/(server quantity allocated) is greater than 0.5, then step S181 (shown in FIG. 20) is performed.

[Step S165] The management server 50 calculates new allocated capacity. In this case, a necessary resource quantity is estimated. A simple method, such as estimating a necessary resource quantity at 50 percent of the resource quantity currently used, the method of estimating a resource quantity needed in the near future from load variations, or the like may be used.

[Step S166] The management server 50 refers to the user information table 112 the wide area load distribution apparatus 100 has, obtains a data center (recommended center) most suitable for each user, and finds the total capacity (optimum value) of resources allocated to users in each data center (recommended center).

[Step S167] The management server 50 refers to the service/user allocation table 113 the wide area load distribution apparatus 100 has, and finds a resource quantity (allocated capacity) allocated to each data center.

[Step S168] The management server 50 calculates the differential between the optimum value and the allocated capacity for each data center.

[Step S169] The management server 50 determines whether steps S170 through S172 have been performed on all the data centers. If steps S170 through S172 have been performed on all the data centers, then step S173 is performed. If there is a data center on which steps S170 through S172 have not been performed yet, then step S170 is performed.

[Step S170] The management server 50 selects a data center in ascending order of differential between optimum value and allocated capacity.

[Step S171] The management server 50 refers to the service/user allocation table 113 and determines whether allocated capacity for the selected data center is smaller than or equal to a minimum allocated quantity. If the allocated capacity is smaller than or equal to the minimum allocated quantity, then step S173 is performed. If the allocated capacity is greater than the maximum allocated quantity, then step S172 is performed.

[Step S172] The management server 50 sets so that one server will be removed from the selected data center. Step S169 is then performed.

[Step S173] The management server 50 requests the wide area load distribution apparatus 100 to perform a rearrangement process on all the users.

[Step S174] After a rearrangement process has been performed on all the users, the management server 50 performs a server real allocation cancel process. The process then terminates.

FIG. 20 is the second half of the flow chart showing the procedure for the under- or overcapacity determination process. The process shown in FIG. 20 will now be described in order of step number.

[Step S181] The management server 50 determines whether the value of (capacity currently used)/(server quantity allocated) is greater than or equal to 0.9 (usage is not smaller than 90%). If the value of (capacity currently used)/(server quantity allocated) is greater than or equal to 0.9, then step S182 is performed. If the value of (capacity currently used)/(server quantity allocated) is smaller than 0.9, then the process terminates.

[Step S182] The management server 50 calculates new allocated capacity. In this case, a necessary resource quantity is estimated. A simple method, such as estimating a necessary resource quantity at 200 percent of the resource quantity currently used, the method of estimating a resource quantity needed in the near future from load variations, or the like may be used.

[Step S183] The management server 50 refers to the user information table 112 the wide area load distribution apparatus 100 has, obtains a data center (recommended center) most suitable for each user, and finds the total capacity (optimum value) of resources allocated to users in each data center (recommended center).

[Step S184] The management server 50 refers to the service/user allocation table 113 the wide area load distribution apparatus 100 has, and finds a resource quantity (allocated capacity) allocated to each data center.

[Step S185] The management server 50 calculates the differential between the optimum value and the allocated capacity for each data center.

[Step S186] The management server 50 determines whether steps S187 through S190 have been performed on all the data centers. If steps S187 through S190 have been performed on all the data centers, then step S191 is performed. If there is a data center on which steps S187 through S190 have not been performed yet, then step S187 is performed.

[Step S187] The management server 50 selects a data center in descending order of differential between optimum value and allocated capacity.

[Step S188] The management server 50 refers to the service/user allocation table 113 and determines whether allocated capacity for the selected data center is greater than or equal to a maximum allocated quantity. That is to say, the management server 50 determines whether resources allocated to the selected data center are sufficient to allocate all of the users for whom the selected data center is a recommended center. If the allocated capacity is greater than or equal to the maximum allocated quantity, then step S191 is performed. If the allocated capacity is smaller than the maximum allocated quantity, then step S189 is performed.

[Step S189] The management server 50 determines whether there is a free server (server for which a value in the Allocated column in the service/user allocation table 113 is zero) in the selected data center. If there is a free server in the selected data center, then step S190 is performed. If there is no free server in the selected data center, then step S186 is performed.

[Step S190] The management server 50 adds one free server to the selected data center. That is to say, the resource quantity allocated to the selected data center is increased. Step S184 is then performed to recalculate allocated capacity.

[Step S191] The management server 50 performs a server real allocation process.

[Step S192] The management server 50 performs a rearrangement process on all the users. The process then terminates.

The above under- or overcapacity determination process is performed regularly. For example, this process is performed every several second to several minutes.

In this under- or overcapacity determination process, it is first ascertained that a server configuration change process is not being performed. Total capacity currently used by users and total capacity allocated as servers are then calculated. When (total capacity currently used by users)/(total capacity allocated as servers) becomes smaller than or equal to a certain value (0.5, for example), the determination that the percentage of excess servers is high is made and a server removal process is performed.

In the server removal process, a necessary resource quantity is estimated first. A resource quantity required in each data center (recommended center) to allocate users and a resource quantity allocated to each data center are then calculated. A server is selected from a data center in which the percentage of excess resources is high as an object of removal. After the server to be removed is determined, all users are reallocated to the remaining servers. As a result, users who use the server to be removed are moved to the servers which continue to operate. The server used by no user is not allocated to a service any longer by on-demand control.

When (total capacity currently used by users)/(total capacity allocated as servers) becomes greater than or equal to a certain value (0.9, for example), the determination that the server resources are running short is made and a server addition process is performed. A resource quantity required in each data center (recommended center) to allocate users and a resource quantity allocated to each data center are then calculated. A server to be added to a data center for which the percentage of allocated resources is low is selected. After the server to be added is determined, an on-demand server allocation process is performed. After the allocation process is completed, a user allocation reoptimization process is performed.

A process performed by an intra-center load distribution unit will now be described.

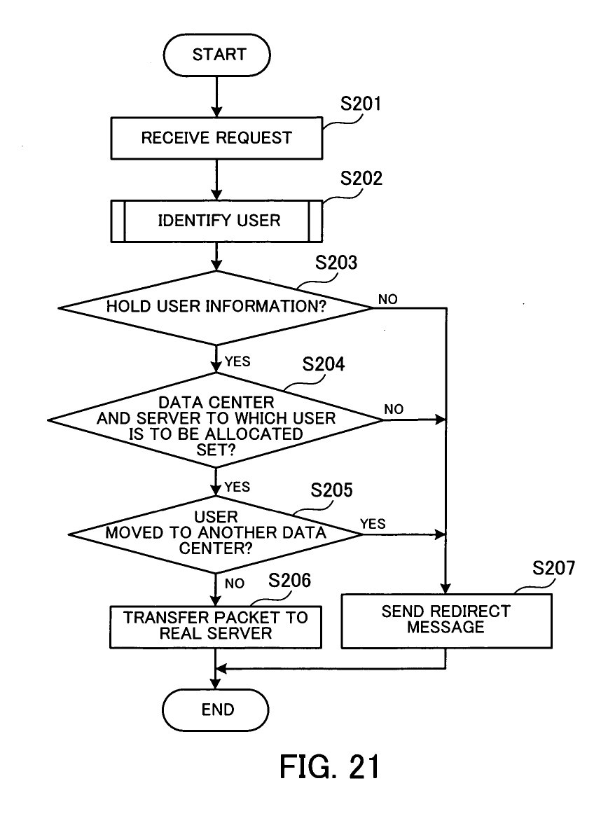

FIG. 21 is a flow chart showing the procedure for a process performed by an intra-center load distribution unit. The process shown in FIG. 21 will now be described in order of step number.

[Step S201] An intra-center load distribution unit receives a request from a client.

[Step S202] The intra-center load distribution unit performs a user identification process. The details of the user identification process are the same as those of the user identification process in FIG. 10 performed by the wide area load distribution apparatus 100.

[Step S203] The intra-center load distribution unit determines whether it holds user information regarding a user who outputted the request (whether the user is set as a user to which a service should be provided). If the intra-center load distribution unit holds the user information, then step S204 is performed. If the intra-center load distribution unit does not hold the user information, then step S207 is performed.

[Step S204] The intra-center load distribution unit determines whether a data center and a server to which the user is to be allocated have been set. If a data center and a server to which the user is to be allocated have been set, then step S205 is performed. If a data center and a server to which the user is to be allocated have not been set, then step S207 is performed.

[Step S205] The intra-center load distribution unit determines whether a move to another data center is set as a data center to which the user is to be allocated. If the user is moved to another data center, then step S207 is performed. If the user is not moved to another data center, then step S206 is performed.

[Step S206] The intra-center load distribution unit transfers a request packet to a server in the same data center. The process then terminates.

[Step S207] The intra-center load distribution unit sends the client a redirect message for making the client reaccess the wide area load distribution apparatus 100. The process then terminates.

In summary, when the intra-center load distribution unit receives a request from a user, the intra-center load distribution unit checks user information regarding the user. If the user information does not reside in a server or a move to another server is set, then the intra-center load distribution unit gives the user instructions to reaccess the wide area load distribution apparatus 100. In addition, when the intra-center load distribution unit receives the request from the user, the intra-center load distribution unit determines whether information regarding the user and a server to which the user is to be allocated are set. If information regarding the user and a server to which the user is to be allocated are set, then the intra-center load distribution unit relays the request to the server. If information regarding the user does not reside, then the intra-center load distribution unit gives the user instructions to reaccess the wide area load distribution apparatus 100. As a result, the wide area load distribution apparatus 100 determines a user class and performs a server allocation process.

A process performed by a server will now be described in detail.

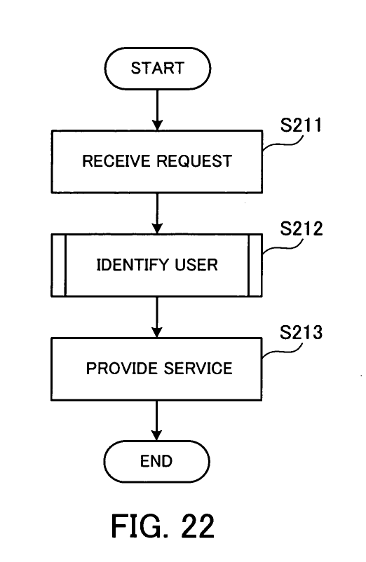

FIG. 22 is a flow chart showing the procedure for a process performed by a server. The process shown in FIG. 22 will now be described in order of step number.

[Step S211] A server receives a request from a client.

[Step S212] The server performs a user identification process. The details of the user identification process are the same as those of the user identification process in FIG. 10 performed by the wide area load distribution apparatus 100.

[Step S213] The server performs a process corresponding to the request and provides a service. The server then returns a processing result to the client.

The operation of a client will now be described.

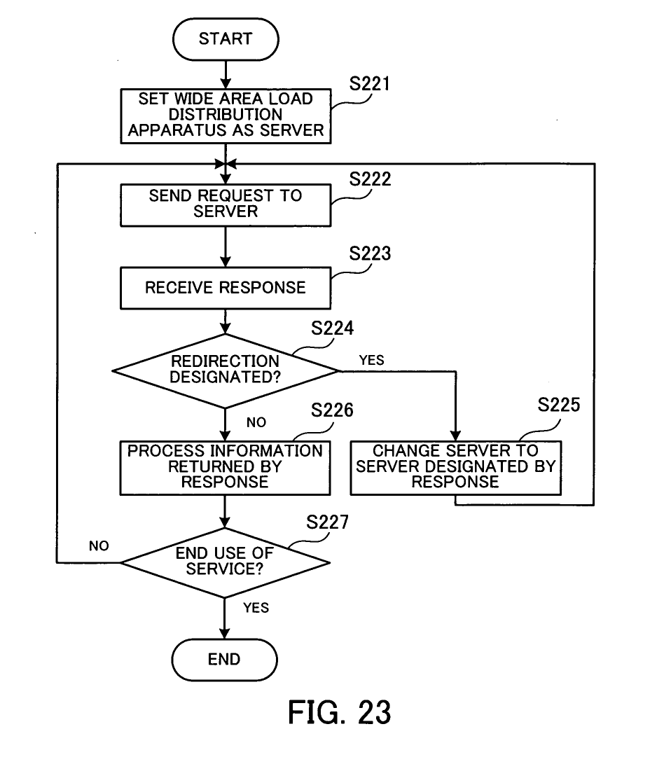

FIG. 23 is a flow chart showing the procedure for a process performed by a client. The process shown in FIG. 23 will now be described in order of step number.

[Step S221] A client sets an IP address of the wide area load distribution apparatus 100 as a server which it should access.

[Step S222] The client sends a request to the server set as a server which it should access.

[Step S223] The client receives a response to the request.

[Step S224] The client determines whether redirection is designated in the response. If redirection is designated in the response, then step S225 is performed. If redirection is not designated in the response, then step S226 is performed.

[Step S225] The client changes a server which it should access from the wide area load distribution apparatus 100 to a server (key IP address of a data center) designated by the redirection.

[Step S226] The client performs a process by using information returned by the response (displays the information obtained on a screen, for example).

[Step S227] The client determines whether it should end the use of a service. For example, if a user performs input operation to end the use of the service, then the client determines that it should end the use of the service. If the use of the service ends, then the process terminates. If the use of the service does not end, then step S222 is performed.

In summary, to use a service, a client first sends an initial request to the wide area load distribution apparatus 100. In this case, the client considers the wide area load distribution apparatus 100 as an ordinary server. The wide area load distribution apparatus 100 returns a response which designates redirection. Accordingly, the client changes a server it should access from the wide area load distribution apparatus 100 to the server designated in the response, and resends the same request to the server. After that, if the client receives a response which designates redirection, then the client changes a server and resends the request. If the client receives an ordinary response, then the client uses a service.

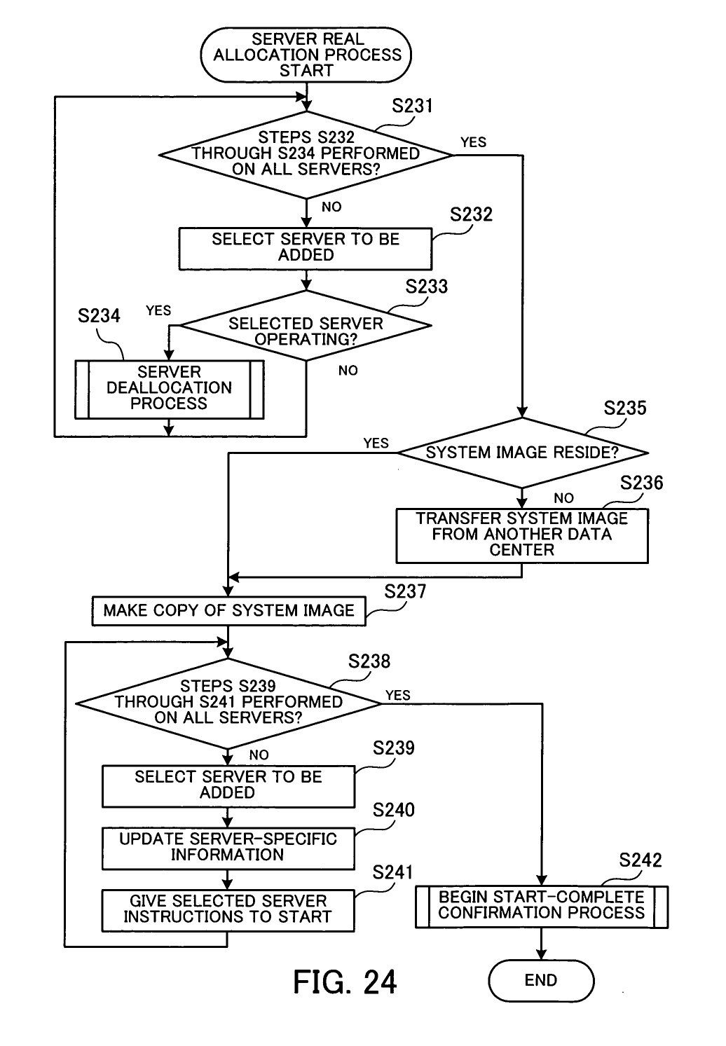

A server addition and deallocation process will now be described with reference to FIGS. 24 through 26. In this process an example of a method for server addition and deallocation in on-demand operation is described and another method may be used for doing an on-demand arrangement.

FIG. 24 is a flow chart showing the procedure for a server real allocation process. The process shown in FIG. 24 will now be described in order of step number.

[Step S231] The management server 50 determines whether steps S232 through S234 have been performed on all the servers. If steps S232 through S234 have been performed on all the servers, then step S235 is performed. If there is a server on which steps S232 through S234 have not been performed yet, then step S232 is performed.

[Step S232] The management server 50 selects a server to be added.

[Step S233] The management server 50 determines whether the server selected is operating. If the server selected is operating, then step S234 is performed. If the server selected is not operating, then step S231 is performed.

[Step S234] The management server 50 performs a deallocation process (real allocation cancel process) on the server selected. Step S231 is then performed.

[Step S235] The management server 50 determines whether a necessary system image resides in any server in a data center on which a process is to be performed. In this case, a system image is a set of all the data (including an OS program, application programs, and management information such as environment setting) necessary for building a service environment on a server. If a necessary system image resides, then step S237 is performed. If a necessary system image does not reside, then step S236 is performed.

[Step S236] The management server 50 makes another data center transfer a system image to the data center in which a system image does not reside.

[Step S237] The management server 50 has a server in the data center which holds the system image make a copy of the system image.

[Step S238] The management server 50 determines whether steps S239 through S241 have been performed on all the servers. If steps S239 through S241 have been performed on all the servers, then step S242 is performed. If there is a server on which steps S239 through S241 have not been performed yet, then step S239 is performed.

[Step S239] The management server 50 selects a server to be added.

[Step S240] The management server 50 updates server-specific information included in the copy of the system image.

[Step S241] The management server 50 gives the selected server instructions to start from the copy of the system image. Step S238 is then performed.

[Step S242] The management server 50 begins a server start-complete confirmation process. The process then terminates.

In summary, if a server on which a process is to be performed is operating, then instructions to end (instructions to perform a deallocation process) are given to the server. Whether a system image for a service to be started already resides in a data center on which allocation is to be performed is then checked. If a system image for a service to be started does not reside in the data center, then a file system is copied from another data center to the data center. A copy of the system image is made for a server operated in the data center, and is associated with the real server (setting server-specific information). Instructions to start a system from the copy of the system image are given to the server. As a result, a server which can provide the predetermined service is added to the data center.

A start-complete confirmation process will now be described in detail.

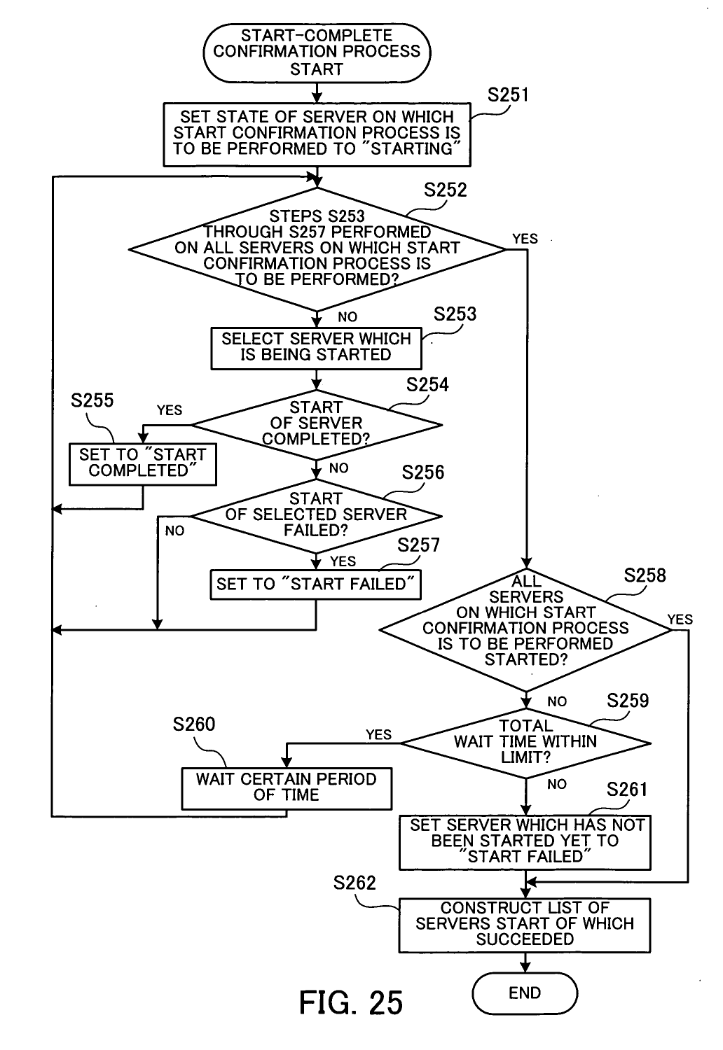

FIG. 25 is a flow chart showing the procedure for a server start-complete confirmation process. The process shown in FIG. 25 will now be described in order of step number.

[Step S251] The management server 50 sets “starting” as information indicative of the state of a server on which a start confirmation process is to be performed.

[Step S252] The management server 50 determines whether steps S253 through S257 have been performed on all servers on which a start confirmation process is to be performed. If steps S253 through S257 have been performed on all servers on which a start confirmation process is to be performed, then step S258 is performed. If there is a server on which steps S253 through S257 have not been performed yet, then step S253 is performed.

[Step S253] The management server 50 selects a server which is being started.

[Step S254] The management server 50 monitors the server selected, and determines whether the start is completed. If the start is completed, then step S255 is performed. If the start is not completed, then step S256 is performed.

[Step S255] The management server 50 sets the state of the selected server to “start completed”. Step S252 is then performed.

[Step S256] The management server 50 determines whether the start of the selected server failed. If the start of the selected server failed, then step S257 is performed. If the selected server is still being started, then step S252 is performed.

[Step S257] The management server 50 sets the state of the selected server to “start failed”. Step S252 is then performed.

[Step S258] The management server 50 determines whether all of the servers on which a start confirmation process is to be performed have been started. If all of the servers on which a start confirmation process is to be performed have been started, then step S262 is performed. If there is a server the start of which failed, then step S259 is performed.

[Step S259] The management server 50 determines whether total wait time after the beginning of the process is within a predetermined limit. If total wait time after the beginning of the process is within the predetermined limit, then step S260 is performed. If total wait time after the beginning of the process exceeds the predetermined limit, then step S261 is performed.

[Step S260] The management server 50 waits a certain period of time and then proceeds to step S252.

[Step S261] The management server 50 sets the state of the server which has not been started yet to “start failed”.

[Step S262] The management server 50 constructs a list of servers the start of which succeeded. The process then terminates.

In summary, whether a server has been started is checked. If there is a server on which the determination that a start is completed or that a start failed is not made, then the check is repeated until a predetermined period time elapses. When the determination that a start is completed or that a start failed is made on all servers or a certain period of time elapsed, information regarding servers the start of which succeeded is generated.

A server real allocation cancel process will now be described.

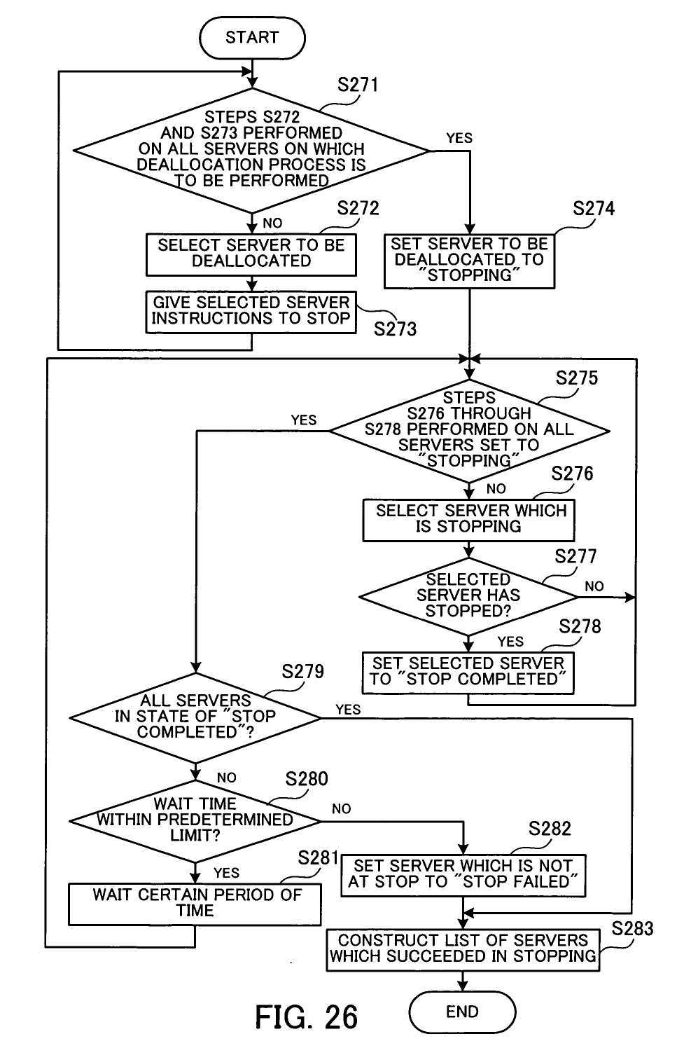

FIG. 26 is a flow chart showing the procedure for a server real allocation cancel process. The process shown in FIG. 26 will now be described in order of step number.

[Step S271] The management server 50 determines whether steps S272 and S273 have been performed on all servers to be deallocated. If steps S272 and S273 have been performed on all servers to be deallocated, then step S274 is performed. If there is a server to be deallocated on which steps S272 and S273 have not been performed yet, then step S272 is performed.

[Step S272] The management server 50 selects a server to be deallocated.

[Step S273] The management server 50 gives the selected server instructions to stop. Step S271 is then performed.

[Step S274] The management server 50 sets the server to be deallocated to “stopping”.

[Step S275] The management server 50 determines whether steps S276 through S278 have been performed on all servers set to “stopping”. If steps S276 through S278 have been performed on all servers set to “stopping,” then step S279 is performed. If there is a server on which steps S276 through S278 have not been performed yet, then step S276 is performed.

[Step S276] The management server 50 selects a server which is stopping.

[Step S277] The management server 50 determines whether the selected server has stopped. If the selected server has stopped, then step S278 is performed. If the selected server has not stopped, then step S275 is performed.

[Step S278] The management server 50 sets the state of the selected server to “stop completed” and then proceeds to step S275.

[Step S279] After the management server 50 determines whether each of all the servers to be deallocated has stopped, the management server 50 determines whether all the servers to be deallocated are in a state of “stop completed”. If all the servers to be deallocated are in a state of “stop completed,” then step S283 is performed. If there is a server which is not in a state of “stop completed,” then step S280 is performed.

[Step S280] The management server 50 determines whether wait time is within a predetermined limit (ten minutes, for example). If wait time is within the predetermined limit, then step S281 is performed. If wait time exceeds the predetermined limit, then step S282 is performed.

[Step S281] If wait time is within the predetermined limit, then the management server 50 waits a certain period of time (ten seconds, for example) and proceeds to step S275.

[Step S282] If wait time exceeds the predetermined limit, then the management server 50 sets the state of the server which is not at a stop to “stop failed”.

[Step S283] The management server 50 constructs a list of servers which succeeded in stopping and which are in a state of “stop completed”. The process then terminates.

In summary, in the server real allocation cancel process, instructions to stop are given to all servers that the process is to be performed on. A server stop process includes terminating service handling, transferring necessary data to a fixed server, and shutting down a system. After all the servers stop or a certain period of time elapsed, information regarding servers which succeeded in stopping is generated.

Service quality specified by a user class can be maintained for each user in this way. As a result, a service of fine quality can always be provided to a user. A service provider can provide services of high added value.

In addition, guaranteed service quality values (maximum values of processing delay time guaranteed to clients) may differ among different service types. Moreover, guaranteed service quality values may differ among different users for whom priority is set. According to the relative positions of a client and the data centers, a data center which provides a service can be selected or reallocated and a data center which guides a request from the client can be selected or reallocated. This enables flexible service operation and a guarantee of service quality which have conventionally been impossible.

The entire flow of the process by the above embodiment will now be described by giving a concrete example.

In the following concrete example, it is assumed that an electronic commerce service is provided by an EC site on the Internet. In this example, providing catalog information, carrying out a purchase procedure, and the like is performed on a server in one of the data centers 200, 300, 400 operated on demand. The management or handling of purchase information, settlements, and the like is performed on the back-end server 60.

An ordinary Web browser is used as software used on a client for using a service. A general user will use a service, so it is difficult to request him/her to, for example, install an application dedicated to the client. Accordingly, in the following concrete example it is assumed that processes, such as moving between data centers, are performed by using the standard functions of an ordinary Web browser.

The flow of handling a request from the client will now be described.

1. Basic Flow of the Process

In a typical network structure like that shown in FIG. 2, a user operates a client included in one of the client groups 41, 42, and 43 and inputs instructions to perform handling to a Web browser. The Web browser on the client then sends a request to the wide area load distribution apparatus 100.

For example, the IP address of the wide area load distribution apparatus 100 may be registered with the domain name system (DNS) as an IP address corresponding to a host name (www.xxx.com) included in the URL (http://www.xxx.com, for example) of a service opened to the public. In this example, the Web browser used by the user does not have user identification data, so user information is not included in the request sent.

When the wide area load distribution apparatus 100 receives the request sent by the Web browser on the client, the wide area load distribution apparatus 100 analyzes the contents of the request. That is to say, the wide area load distribution apparatus 100 determines which service the request sent from the user needs, whether user information is included in the request, and which user sent the request. In this example, user information is not included in the request sent from the user, so the wide area load distribution apparatus 100 fails in user identification. As a result, the user is set to a default class.

The wide area load distribution apparatus 100 determines the type of a service to be provided on the basis of the request sent by the Web browser. If one wide area load distribution apparatus 100 is used for providing services of a single type, then the wide area load distribution apparatus 100 determines that all requests need services of this type.

On the other hand, if the wide area load distribution apparatus 100 is used for providing services of plural types, then a plurality of IP addresses are assigned to the wide area load distribution apparatus 100 according to service types and a service type is identified by an IP address designated as the destination of the request. The following methods may be used. Different TCP port numbers are used according to service types and a service type is identified by a TCP port number. In addition, different pieces of identification data, such as different URLs, are assigned according to service types, and a service type is identified by referring to a fully qualified domain name (FQDN) indicated in a Host line included in a request header.

On the basis of a user class and a service type, the wide area load distribution apparatus 100 determines a data center and a server allocated to the user. In addition, the wide area load distribution apparatus 100 issues unique identification data to the new user and registers the identification data in the wide area load distribution apparatus 100, an intra-center load distribution unit in the data center to be used, and the server to be used.

The wide area load distribution apparatus 100 then returns a redirect message where the user identification data and the intra-center load distribution unit in the data center to which the request is to be redirected are designated to the Web browser. The Web browser receives the redirect message and resends a request to the intra-center load distribution unit designated therein. At this time the Web browser also sends the user data it received from the wide area load distribution apparatus 100. The server transfer stipulated in the HTTP can be used as a method for redirection. To be concrete, the method of returning a new server by returning, for example, the response “301 Moved Permanently,” the method of updating a page with a meta-tag (“<META HTTP-EQUIV=“Refresh” CONTENT=“0;URL”>”), or the like can be used.

The intra-center load distribution unit which received the request from the user analyzes the request in the same way that is used by the wide area load distribution apparatus 100. The intra-center load distribution unit then specifies a real processing server on the basis of the user identification data and transfers the request to the server. The intra-center load distribution unit relays the request to the server and a response from the server at the packet level.

The server which received the request generates a response and returns it to the Web browser. After that the same process that is performed for providing an ordinary Web service is begun between the Web browser, the intra-center load distribution unit, and the server.

2. Update of User Identification Data and User Class Information

By performing the process described in the preceding clause, providing a service is begun. At this time, however, the user has not been classified into a desirable class yet. Therefore, it is necessary to give correct class information to the user. In this case, user authentication is performed first in some way or other. This user authentication is the same as a log in process performed in the case of providing an ordinary Web service. If the authentication succeeded, then the user must be moved to a proper class. For example, each server sets a correct class corresponding to the user identification data in the wide area load distribution apparatus 100. At this time the server sets so that the wide area load distribution apparatus 100 will perform reallocation. In addition, a redirect message is returned to the user to make the user reaccess the wide area load distribution apparatus 100. In response to a request from the user, the wide area load distribution apparatus 100 performs an allocation process again on the basis of the class information. The wide area load distribution apparatus 100 then moves information from the old server to a new server and updates management information the wide area load distribution apparatus 100 and the intra-center load distribution unit hold.

3. Move of Another User Due to the Allocation of a User of a Higher Priority Class

It is necessary to handle a request from a user of a higher priority class (high class user) before a request from a user of a lower priority class (low class user) Accordingly, a high class user is allocated to the most suitable data center if there is no user of the same class or a higher class. In this case, a low class user may be moved to another data center or the providing of a service to a low class user may be interrupted. After a server is added, the providing of the service to the low class user is resumed. Actually, an estimate is made and a server is added. Therefore, the providing of a service will be interrupted only if there is a fatal mistake of an estimate.

An example of the case where a high class user newly sends a request will now be given. A user sends a request to the wide area load distribution apparatus 100 in the usual way (for the sake of simplicity it is assumed that at this point in time a user class has been set). The wide area load distribution apparatus 100 determines the class from the request and allocates a server to the request. If there is sufficient free capacity in a data center most suitable for the user, then an allocation process is performed in the usual way. However, if unused capacity in the data center most suitable for the user is insufficient and low class users use this data center, then a low class user is moved to another data center and the user is allocated to the data center.

To be concrete, the total of the unused capacity and capacity used by the low class users is used as free capacity and a data center to which the user is allocated is determined. If capacity necessary for allocating the user must be secured by using the capacity currently used by the low class users, then a low class user to be moved for securing necessary capacity is selected and the same allocation process is performed again on the selected low class user. If still another user is moved, then a move process is repeated until all users are finally allocated or until free capacity is exhausted. For each user for whom a change of server is made, user-specific information is moved between servers and information set in the wide area load distribution apparatus 100 and an intra-center load distribution unit is changed. In addition, a redirect message is sent to each user to make him/her reaccess the wide area load distribution apparatus 100.

4. Increase in the Number of Servers with an Increase in the Number of Users

A process performed when server capacity is expanded with an increase in the number of users will now be described.

There are two main reasons for expanding server capability. One reason is that before capacity becomes insufficient, the capacity is increased on the basis of load variations observed and an estimate of the load. The other reason is that there is no unused capacity which can be allocated due to a sharp rise in the load, a server failure, or the like (server capability should be expanded for the former reason so that the latter reason will be brought forward as little as possible).

As a simple method, whether the capacity is insufficient may be determined by a percentage. For example, if (used capacity)/(total capacity) exceeds 90%, then the determination that the capacity is insufficient is made. Whether the possibility that the capacity becomes insufficient in the near future is strong may be determined on the basis of an estimate of the load.

If lack of total capacity is detected, then the wide area load distribution apparatus 100 calculates capacity currently required. As the simplest method, the capacity currently required may be estimated at 130 percent of capacity currently used. In addition, capacity required in the future may be estimated by using a linear approximation based on load variations in the past and taking into consideration time taken to add a server.

The wide area load distribution apparatus 100 then calculates capacity required in each data center in the case of all the current users being arranged in their recommended data center and the total capacity of servers currently allocated to each data center. The management server 50 which received instructions from the wide area load distribution apparatus 100 allocates an additional server to a data center in descending order of differential between capacity required and capacity allocated (in descending order of deficiency in resource quantity).

After the allocation process is completed, the wide area load distribution apparatus 100 rearranges all the users on the basis of a new arrangement of the data centers. This process is performed by selecting a data center a user can use in descending order of priority. In this case, the same server may continuously be allocated to a user who continues to use the same data center in order to reduce the number of users to be moved.

5. Reduction in the Number of Servers with a Reduction in the Number of Users

If the determination that server capacity allocated is excessive is made because of a reduction in the number of the users, then a server lease is performed to reduce excess capacity. As a simple method, whether the server capacity is excessive may be determined by a percentage. For example, if (capacity currently used)/(allocated capacity) is smaller than 50%, then the determination that the server capacity is excessive is made. Whether the server capacity is excessive in comparison to server capacity required for the time being may be determined on the basis of an estimate of the load.

If the determination that the server capacity is excessive is made, then the wide area load distribution apparatus 100 calculates capacity currently required. As a simple method, the capacity currently required may be estimated at, for example, 130 percent of the capacity currently used.

The wide area load distribution apparatus 100 then rearranges users on the basis of a new arrangement of servers. This process is basically the same as that performed for adding a server, except that reallocation is performed in a state in which the number of servers has been reduced. After the reallocation of the users is completed, the management server 50 performs the process of stopping a server selected as an excess server in response to a request from the wide area load distribution apparatus 100.

As stated above, by dynamically determining the allocation of users to the data centers and properly reallocating all the users, services of high quality can continuously be provided to users.

The above functions can be realized with a computer. In this case, a program in which the contents of the functions each load distribution unit and the management server should have are described is provided. By executing this program on the computer, the above functions are realized on the computer. This program can be recorded on a computer readable record medium. A computer readable record medium can be a magnetic recording device, an optical disk, a magneto-optical recording medium, a semiconductor memory, or the like. A magnetic recording device can be a hard disk drive (HDD), a flexible disk (FD), a magnetic tape, or the like. An optical disk can be a digital versatile disk (DVD), a digital versatile disk random access memory (DVD-RAM), a compact disk read only memory (CD-ROM), a compact disk recordable (CD-R)/rewritable (CD-RW), or the like. A magneto-optical recording medium can be a magneto-optical disk (MO) or the like.

To place the program on the market, portable record media, such as DVDs or CD-ROMs, on which it is recorded are sold. Alternatively, the program is stored in advance on a hard disk in a server computer and is transferred from the server computer to another computer via a network.

When the computer executes this program, it will store the program, which is recorded on a portable record medium or which is transferred from the server computer, on, for example, its hard disk. Then the computer reads the program from its hard disk and performs processes in compliance with the program. The computer can also read the program directly from a portable record medium and perform processes in compliance with the program. Furthermore, each time the program is transferred from the server computer, the computer can perform processes in turn in compliance with the program it receives.

The present invention is not to be construed as limited to the above embodiment. Various other modifications and changes can be made without departing from the spirit and scope of the present invention.

In the present invention, a request is allocated according to the position on a network of a client so that a service will be provided to the client by a data center by which delay time becomes short. Therefore, a service of high quality can be provided to each client by efficiently operating data centers dispersed on the network.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A record medium on which a load distribution program for dynamically allocating requests from clients to a plurality of data centers is recorded, the program making a computer function as:
delay time determination means for analyzing a request sent from a client, for identifying a position on a network of the client, and for determining processing delay time the client takes to receive a response from each data center on the basis of a communication path between the position of the client and a position on the network of each data center;
allocation determination means for preferentially selecting a data center which can provide a service to the client after shortest processing delay time as a recommended data center on the basis of the processing delay time determined by the delay time determination means; and
service allocation means for making a server in the recommended data center provide the service to the client which outputted the request.

2. The record medium with the load distribution program recorded thereon according to claim 1, wherein the delay time determination means specifies a client connection server to which the client is connected on the basis of a source address included in the request and determines the processing delay time taken between the client and each data center on the basis of a position of the client connection server specified.

3. The record medium with the load distribution program recorded thereon according to claim 2, wherein the delay time determination means refers to a delay time management table where communication delay time taken between the client connection server which provides an Internet connection service to the client and each data center is set in advance and determines the processing delay time taken between the client and each data center.

4. The record medium with the load distribution program recorded thereon according to claim 1, wherein if an excess resource for performing a process corresponding to the request is not left in the recommended data center, the service allocation means enhances processing capability of the recommended data center.

5. The record medium with the load distribution program recorded thereon according to claim 4, wherein until completion of enhancement of the processing capability of the recommended data center, the service allocation means temporarily makes another data center provide the service to the client which outputted the request.

6. The record medium with the load distribution program recorded thereon according to claim 1, wherein the allocation determination means selects a data center for which a maximum value of permissible processing delay time is set in advance as permissible delay time, for which the permissible delay time is guaranteed, and in which an excess resource for performing a process corresponding to the request is left as the recommended data center.

7. The record medium with the load distribution program recorded thereon according to claim 6, wherein the allocation determination means determines the permissible delay time which is set for each service class indicative of guaranteed service quality at the time of allocating the request on the basis of a service class to which a user who uses the client belongs.

8. The record medium with the load distribution program recorded thereon according to claim 1, wherein if an excess resource for performing a process corresponding to the request is not left in the recommended data center, the allocation determination means secures a resource by stopping the providing of a service to a user who belongs a service class lower in priority set for each service class indicative of guaranteed service quality than a service class to which a user who uses the client belongs.

9. The record medium with the load distribution program recorded thereon according to claim 1, wherein the allocation determination means reallocates all users to which services are provided by the plurality of data centers to the plurality of data centers at predetermined timing.

10. A load distribution method for dynamically allocating requests from clients to a plurality of data centers with a computer, the method comprising the steps of:
by delay time determination means, analyzing a request sent from a client, identifying a position on a network of the client, and determining processing delay time the client takes to receive a response from each data center on the basis of a communication path between the position of the client and a position on the network of each data center;
by allocation determination means, preferentially selecting a data center which can provide a service to the client after shortest processing delay time as a recommended data center on the basis of the processing delay time determined by the delay time determination means; and
by service allocation means, making a server in the recommended data center provide the service to the client which outputted the request.

11. A load distribution apparatus for dynamically allocating requests from clients to a plurality of data centers, the apparatus comprising:
delay time determination means for analyzing a request sent from a client, for identifying a position on a network of the client, and for determining processing delay time the client takes to receive a response from each data center on the basis of a communication path between the position of the client and a position on the network of each data center;
allocation determination means for preferentially selecting a data center which can provide a service to the client after shortest processing delay time as a recommended data center on the basis of the processing delay time determined by the delay time determination means; and
service allocation means for making a server in the recommended data center provide the service to the client which outputted the request.
